(19) United States
(12) Patent Application Publication
(10) Pub. No.: US 2019/0353280 A1
(43) Pub. Date: Nov. 21, 2019

(54) SMOKETAPE

(71) Applicant: EAS, IP, LLC

(72) Inventors: Ryan C. Dunn, Charlottesville, VA (US); Bryan D. Wright, Charlottesville, VA (US); Donald A. Tubbs, Charlottesville, VA (US); Joshua M. Parman, Palmyra, VA (US)

(21) Appl. No.: 16/306,384

(22) PCT Filed: May 31, 2017
(86) PCT No.: PCT/US17/35327

§ 371 Date: Nov. 30, 2018

(51) Int. Cl. F16L 1/11; G08B 5/40

(52) U.S. Cl. CPC F16L 1/11; G08B 5/40

(57) ABSTRACT

Signal tape (790) is disclosed which helps to prevents damage to buried infrastructure such as a natural gas pipeline. The invention provides an immediate and forceful warning to excavation equipment operators of the proximity of and of impending damage to buried infrastructure. The signal tape (790) comprises a strong core material (793) which may be a woven aramid fiber tape firmly attached to a series of spaced smoke generators (792, 792′). The core material and smoke generators are sealed within thermoplastic layers (796, 796′) of thin tape for environmental protection. A strike by excavation equipment, for example a backhoe bucket will cause the core material to come to the surface where it can be seen. As the core material (793) moves, it ignites at least one smoke generator (792, 792′) which is then pulled to the surface emitting a dense cloud of colored [and odorous] smoke. Portions of the protective tape are also pulled to the surface.

### CROSS-REFERENCE TO RELATED APPLICATIONS

This application claims the benefit under 35 U.S.C. 119(e) of U.S. patent application 62/343,794 filed on 31 May 2016. This invention also uses a portion of the invention disclosed in commonly owned U.S. patent application Ser. No. 14/318,127, filed 27 Jun. 2014.

### STATEMENT REGARDING FEDERALLY SPONSORED RESEARCH OR DEVELOPMENT

Not applicable.

### SEQUENCE LISTING

Not Applicable.

### FIELD OF THE INVENTION

The present invention relates generally to the field of creating a localized warning to prevent damage to buried pipelines and other buried infrastructure.

### BACKGROUND OF THE INVENTION

There are currently three general types of systems used to address the problem of excavation damage to underground utilities. The first type are systems and products that require a proactive excavation crew (e.g. Call 811). The second type are passive visual indicators such as marker tape, marker mesh, and signs on the surface. The third type are monitored video and sensor systems such as acoustic, flyover, and seismic systems.

A modification of passive visual indicators is also known which utilizes an active visual signal produced by excavation equipment operating in the vicinity of the buried infrastructure. In this modification, the passive visual indicator [for example, a continuous marker tape] is modified to comprise a normally inert signal generator which interacts with excavation equipment to produce a visual signal [usually a cloud of smoke] when the normally inert signal generator is activated by being struck by a portion of the excavation equipment, e.g. a backhoe bucket. Some prior art systems in this category are Schertler et al. (U.S. Pat. No. 3,718,113), Hosack (U.S. Pat. No. 3,581,703), and Dunn, et al. (US 2015-0260312 A1-Now U.S. Pat. No. 9,568,121, issued 14 Feb. 2017). Each will provide a visible signal at the site of the potentially damaging activity.

Schertler et al. (U.S. Pat. No. 3,718,113), provides a separated series of discrete chemical smoke generators encased in a continuous outer cover to provide an elongated tubular assembly. Schertler et al. provides a for a single elongated tubular assembly to be buried above the pipeline or, as an alternate, provides for two elongated tubular assemblies buried above the pipeline with one on each side of the pipeline. Hosack (U.S. Pat. No. 3,581,703) provides a continuous tape assembly with multiple, discrete smoke generators provided along the length of the tape. The assembly is then buried just above the pipeline. With both the Schertler et al. and Hosack indicators, when excavation equipment digs near the buried pipeline, the excavation equipment activates the smoke generators in both systems. The Dunn et al. invention provides an elongated tube which will provide a smoke signal when disturbed by excavation equipment. A series of these tubes are buried near the buried pipeline in positions where they will be struck and activated by excavation equipment before the excavation equipment strikes the pipeline.

Currently, marker tape is the standard protective measure used in new installations of pipelines. Laying marker tape, a passive visual indicator, is well known and easily done by pipeline installation crews. In the industry, until now, there has been no available product (signal tape) which assertively provides a vivid signal to an excavator operator of the close proximity and impending damage to a buried pipeline which may be installed in the same manner as marker tape. Embodiments of such signal tape are disclosed herein.

### SUMMARY OF THE INVENTION

The signal tape of the invention provides a localized, immediate and forceful signal to an excavator operator of the immediate proximity of and of impending damage to buried infrastructure. Thus, the excavation equipment operator is forcefully warned to immediately stop excavation operations. The signal provided cannot be misinterpreted since activation of the signal tape creates a signal that intuitively warns of danger. It is noted that the signal tape of the invention may be installed in the same manner, at the same time, by the same crews which now install marker tape, a passive visual marker which often is unseen by an excavator operator and this is ineffective.

The signal tape of the current invention, when triggered, produces an immediate plume of colored gas/smoke of sufficient volume to warn those in the immediate area of danger, but not so large as to alarm those not in close proximity In one embodiment, buried signal tape comprises a series of colored gas/smoke generators connected by a core material comprising wire, fabric or cord with the whole assembly contained within two opposing, protective layers of plastic film. When the wire, fabric or cord is engaged by excavation equipment, it pulls on the signal tape and ignites one or more of the colored gas/smoke generators. The ignited generators are then pulled by the excavation equipment out of the ground by the wire, fabric or cord. The smoke (which may be vividly colored and/or highly odiferous) is easily and readily seen by an excavation equipment operator. No spotter is thus needed in addition to the excavation equipment operator. The cloud of colored gas/smoke will be much more intense than with previous systems because the previous systems require the smoke to be generated underground (at the level of the buried system) and for the smoke to then make its way to the surface. Indeed, with the present invention, an active [ignited and producing smoke] generator is often contained in the excavation bucket itself—so the smoke appears to be coming from the operator's own excavation equipment. As noted above, this sort of signal cannot be misinterpreted and intuitively warns of danger.

It should be noted that the terms colored gas and smoke are used interchangeably throughout this application. Wherever the term “colored gas” is used, it should be understood that the term “smoke” could also be used and they are considered the same for the purposes of this invention. From this point on in this application, only the terms “smoke” and “smoke generator” will be used; however, it should be understood that these terms are intended to mean the same thing as “colored gas” or “colored gas generator”. As noted above, in § [0012], the smoke generated by the smoke generators of this invention may be vividly [brightly] colored and/or highly odiferous. It should also be noted that the terms “tape” and signal tape are used interchangeably herein and mean the same thing. That is a warning device which is designed and constructed to be buried over or near buried infrastructure such as a buried pipeline.

### BRIEF DESCRIPTION OF THE DRAWINGS

FIG. 1 shows a section of signal tape according to a first embodiment of the invention having a first embodiment of a smoke generator according to the invention.

FIG. 2 shows a side view of the signal tape shown in FIG. 1 from the perspective of arrows A-A as shown in FIG. 1.

FIG. 3 shows a section of signal tape having multiple smoke generators as shown in FIG. 1 connected in a series configuration.

FIG. 4 shows a section of signal tape according to a second embodiment of the invention having two parallel strings of smoke generators with each string connected in a series configuration.

FIG. 5 shows a section of signal tape according to a third embodiment of the invention having multiple smoke generators connected in a series configuration.

FIG. 6 shows a roll of signal tape according to the first embodiment of the invention being partially unwound prior to installation.

FIG. 7 shows a second embodiment of a smoke generator for use in a series configuration signal tape according to the invention.

FIG. 8 shows a partial cross-sectional view of the smoke generator of FIG. 7.

FIG. 9 shows another partial cross-sectional view of the smoke generator of FIG. 7.

FIG. 10 shows a third embodiment of a smoke generator for use in use in a series configuration signal tape according to the invention.

FIG. 11 shows a fourth embodiment of a smoke generator for use in use in a series configuration signal tape according to the invention.

FIG. 12 shows a partial cross-sectional view of the smoke generator of FIG. 11.

FIG. 13 shows another partial cross-sectional view of the smoke generator of FIG. 11.

FIG. 14 shows a fifth embodiment of a smoke generator for use in use in a series configuration signal tape according to the invention.

FIG. 15 shows a section of a series configuration signal tape according to this invention having multiple colored gas/smoke generators identical to those shown in FIG. 14.

FIG. 16 shows three colored gas/smoke generators identical to those shown in FIG. 7 connected in parallel for use in a ladder configuration signal tape according to this invention.

FIG. 17 shows a sixth embodiment of a colored gas/smoke generator for use in a ladder configuration signal tape according to this invention.

FIG. 18 shows a cross-section of the colored gas/smoke generator shown in FIG. 17.

FIG. 19 shows a ladder configuration signal tape according to this invention using multiple colored gas/smoke generators as shown in FIGS. 17 and 18.

FIG. 20 shows a ladder configuration signal tape according to this invention using multiple colored gas/smoke generators as shown in FIGS. 17 and 18.

FIG. 21 shows a section of signal tape according to another embodiment of the invention having a smoke generator identical to that shown in FIG. 1; however, the signal tape does not have the ignition spring attached to the igniter portion of the smoke generator.

FIG. 22 shows a side view of the signal tape shown in FIG. 21 from the perspective of arrows B-B as shown in FIG. 21.

FIG. 23 shows a section of signal tape having multiple smoke generators as shown in FIG. 21 connected in a series configuration.

FIG. 24 shows a section of signal tape according to another embodiment of the invention having two parallel strings of smoke generators similar to those shown in FIG. 23, with each string connected in a series configuration.

FIG. 25 shows a section of signal tape according to another embodiment of the invention having multiple smoke generators similar to those shown in FIG. 21 connected in a series configuration.

FIG. 26 shows a section of signal tape according to another embodiment of the invention having a smoke generator identical to that shown in FIG. 1; however, the signal tape does not have the ignition spring attached to the igniter portion of the smoke generator nor does it have the sinusoidal core material of FIG. 1.

FIG. 27 shows a side view of the signal tape shown in FIG. 26 from the perspective of arrows C-C as shown in FIG. 26.

FIG. 28 shows a section of signal tape having multiple smoke generators as shown in FIG. 26 connected in a series configuration with extra core material and the ignition spring shown in FIGS. 1-5 is included in this embodiment of the signal tape.

FIG. 29 shows a section of signal tape similar to that shown in FIG. 24 with smoke generators similar to those shown in FIG. 26 and with extra core material.

FIG. 30 shows a section of signal tape similar to that shown in FIG. 25 but without the sinusoidal core material shown in FIG. 25.

FIG. 31 shows a section of signal tape similar to that shown in FIG. 28 but without the extra core material shown in FIG. 28 and with the ignition spring similar to that shown in FIG. 1.

FIG. 32 shows a section of signal tape similar to that shown in FIG. 29 but without the extra core material shown in FIG. 29.

FIG. 33 shows a cross-section of another embodiment of a smoke generator useful for this invention.

FIG. 34 shows a cross-section of a smoke generator according to the invention similar to that shown in FIG. 33 but with an ignition spring included.

FIG. 35 shows a cross-section of another embodiment of smoke generator useful for this invention with the ignition elements offset to one side of the smoke generator tube.

FIG. 36 shows a cross-section of the smoke generator shown in FIG. 35 but with an ignition spring included.

FIG. 37 shows a cross-section of another embodiment of smoke generator useful for this invention.

FIG. 38 shows across-section of the smoke generator of FIG. 37 but with an ignition spring included.

FIG. 39 shows a smoke generator similar to those shown in FIGS. 33-38 attached to a fabric core material.

FIG. 40 shows a smoke generator similar to those shown in FIGS. 33-38 attached to a fabric core material in a different manner than the attachment shown in FIG. 39.

FIG. 41 shows a smoke generator similar to those shown in FIGS. 33-38 attached to a fabric core material in a different manner than the attachments shown in FIG. 39 or FIG. 40.

FIG. 42 shows a smoke generator similar to those shown in FIGS. 33-38 attached to a chock cord core material in a similar manner than the attachments shown in FIG. 30.

FIG. 43 shows a signal tape with smoke generators similar to those shown in FIG. 40 connected in series with extra fabric core material in a sinusoidal pattern.

FIG. 44 shows a signal tape with smoke generators similar to those shown in FIG. 41 connected in series with extra fabric core material in a sinusoidal pattern.

FIG. 45 shows a signal tape with smoke generators similar to those shown in FIG. 41 connected in series with extra fabric core material in a coil pattern.

FIG. 46 shows a signal tape with smoke generators similar to those shown in FIG. 41 connected in series with no extra fabric core material between the smoke generators.

FIG. 47 shows a signal tape with smoke generators similar to those shown in FIG. 40 connected in series with extra fabric core material in a coil pattern.

FIG. 48 shows a signal tape with smoke generators similar to those shown in FIG. 40 connected in series with no extra fabric core material between the smoke generators.

FIG. 49 shows a signal tape with smoke generators similar to those shown in FIG. 42 connected in series with shock cord core material.

### DETAILED DESCRIPTION OF THE INVENTION

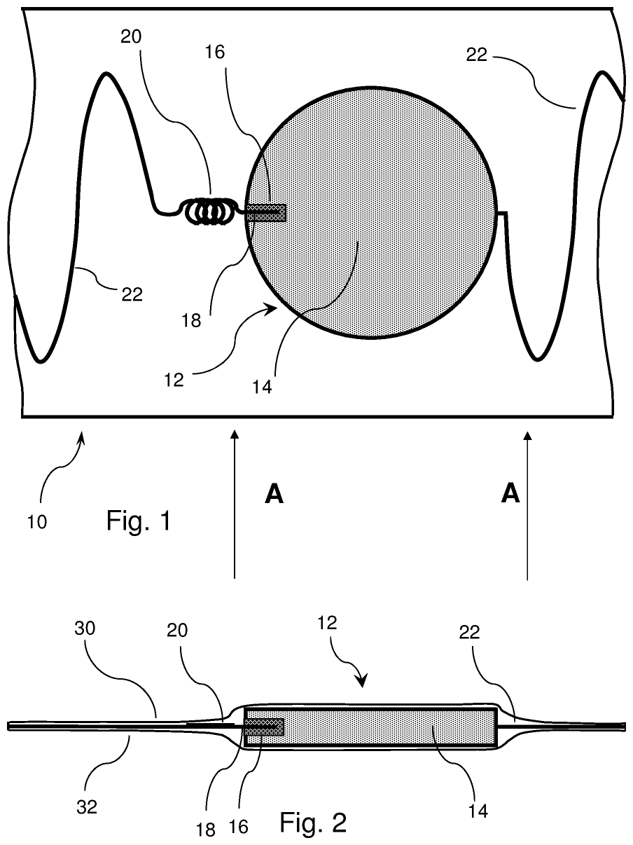

FIGS. 1 and 2 will be described together with it being understood that some reference numerals shown in one figure may not be shown in the other figure. FIG. 1 shows a section of a first embodiment of signal tape 10 with a single smoke generator 12. Smoke generator 12 comprises a conventional smoke generating composition 14 with an igniter portion 16. Ignition wire 18 is embedded in igniter portion 16 and will cause igniter portion 16 to ignite when ignition wire 18 is pulled out of igniter portion 16. Connecting wires 22, which may be 1/16 inch braided wire cable, attach the smoke generators together. As is clearly shown in FIGS. 1, 3, 4, and 5, connecting wires 22 are provided in a sinusoidal pattern between smoke generators 12. This is to provide extra wire to aid in bringing smoke generators 12 to the surface when the signal tape is struck by construction equipment. Connecting wire 22 is attached to one end of ignition spring 20 while the other end of ignition spring 20 is attached to ignition wire 18. Thus, when wire 22 is snagged by excavation equipment, ignition wire 18 will be pulled out of igniter portion 16 causing the smoke generator to be activated. Ignition spring 20 is designed to provide a more even pull on ignition wire 18 to secure more consistent activation of smoke generator 12 in accord with the disclosure of the above-mentioned, commonly-owned U.S. patent application Ser. No. 14/318,127. It has been found that if the pull exerted on connecting wire 22 by the excavation equipment is slow enough, the ignition wire 18 may be slowly pulled out of igniter portion 16 without igniting the igniter portion 16. To prevent this situation, ignition spring 20 has been placed between ignition wire 18 and connecting wire 22. Even a slow pull on connecting wire 22 will now serve to stretch ignition spring 20 and cause it to store energy. Eventually the stored energy in ignition spring 20 will overcome the inertia and friction between igniter portion 16 and ignition wire 18. At this point, the stored energy in ignition spring 20 is released and ignition wire 18 is smoothly and swiftly pulled from igniter portion 16 causing ignition of igniter portion 16 and thus, ignition of smoke generator 12. The entire assembly is encased between two sheets 30 and 32 of plastic tape. FIG. 2 shows a cross-section of signal tape 10 and shows sheets 30 and 32 which may be a known thermoplastic material resistant to soil and soil chemicals. Sheets 30 and 32 enclose all of the elements of the signal tape in a protective sleeve.

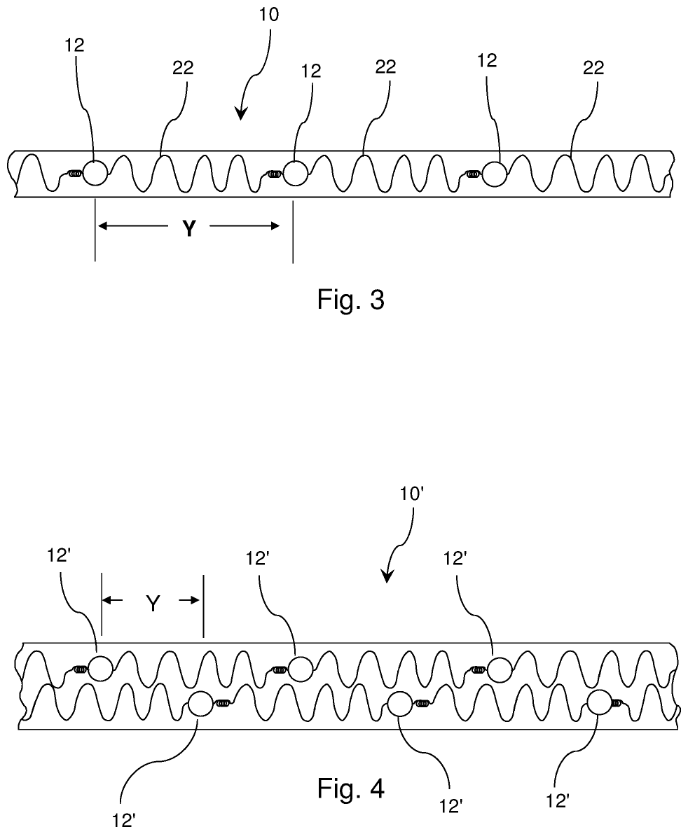

FIG. 3 shows a longer section of signal tape 10 having an array of multiple smoke generators 12 contained therein comprising a series configuration signal tape. Smoke generators 12 are connected by wire 22. The drawings are not made to exact scale. It is to be noted that the smoke generators 12 are intended to be spaced along the length of signal tape 10 at approximately three foot intervals. This is illustrated in FIG. 3 by spacing arrow Y and it is intended that the separation distance denoted by arrow Y is to be approximately 3 feet. It has been found that a three foot spacing works well, but smoke generator spacings of approximately 8 feet have also been used with good results. It is to be understood that the spacing Y could be more or less than three feet according to the exact situations encountered in the field and/or economics, since the spacing of the smoke generators [and, thus, the total number of smoke generators in a given length of signal tape] is one of the principle determinants of the unit cost of the signal tape.

FIG. 4 shows a section of a second embodiment of signal tape 10′ having two arrays comprising multiple smoke generators 12′ connected in a series configuration. The upper array in FIG. 4 is shown with the igniter portions on the left-hand side of smoke generators 12′. The lower array in FIG. 4 is shown with the igniter portions on the right-hand side of smoke generators 12′. The two arrays of interconnected smoke generators are encased within two sheets of plastic tape as shown in FIG. 2. This arrangement gives a more reliable signal.

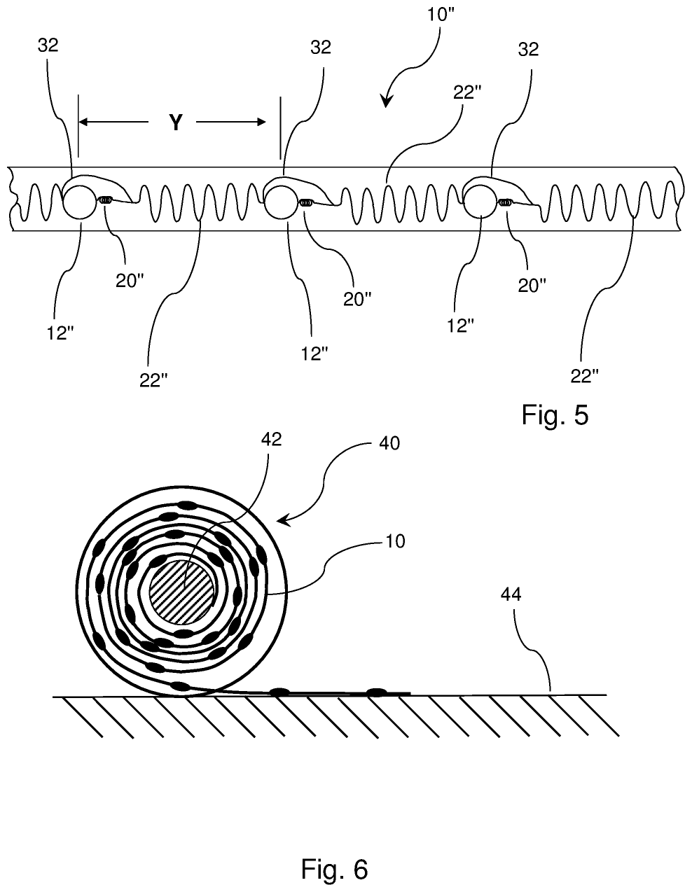

FIG. 5 shows a section of a third embodiment of signal tape 10″. The smoke generators 12″, ignition springs 20″ and connecting wires 22″ are all identical to those shown in FIGS. 1-4. Bridge wire 32 connects the separate connecting wires 22″ together in one continuous string. This provides a continuous electrical pathway for detection in the conventional manner when the signal tape is buried near the underground infrastructure it is designed to protect. Wires 22″ and 32 may be braided for strength or they may be solid. They may be conductive or non-conductive. If conductive, wires 22″ and 32 may be used with known systems and devices to locate a buried conductive wire. Bridge wire 32 also provides extra strength to the array. As in the other signal tape embodiments smoke generators 12″ are shown as being spaced at three foot intervals [Y] along signal tape 10″. This interval is considered suitable for the purposes of the invention, but, as noted above in § [0062] , this interval could be greater or less than three feet, as desired [for example, 8 feet] or as mandated by field conditions and/or economics.

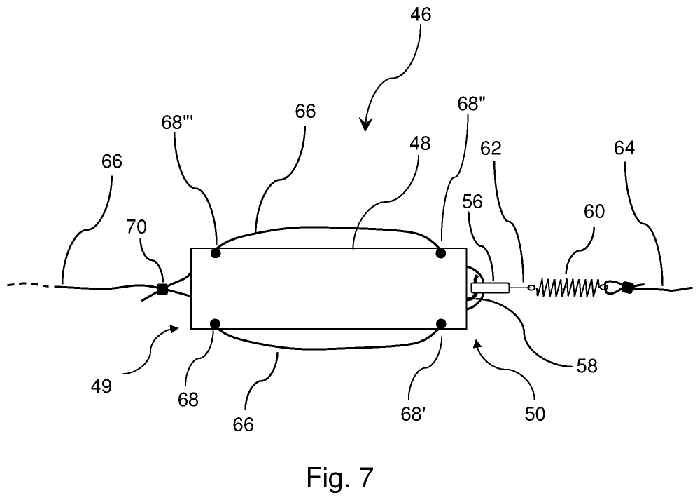

FIG. 6 shows a spool 40 with a large quantity of signal tape 10 wrapped around spindle 42. The signal tape is shown as being partially unwound and lying on the ground surface 44. This figure illustrates how a large quantity of signal tape could be stored and transported to the field to be buried near an underground infrastructure in order to protect same.

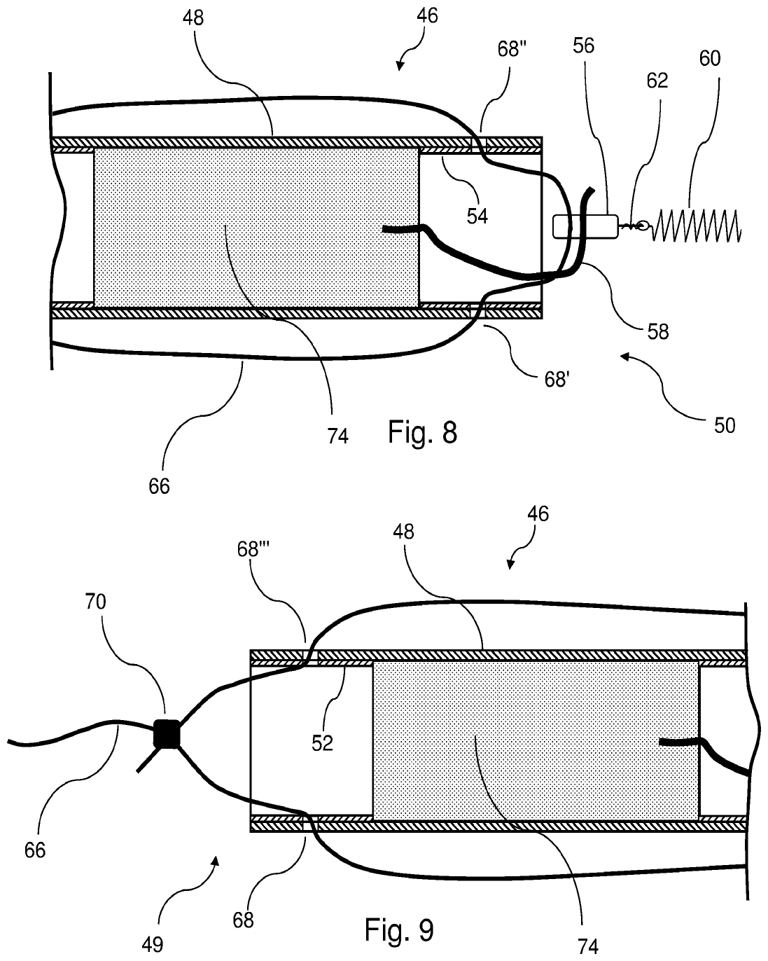

FIG. 7 shows a second embodiment of a smoke generator 46 intended to be used in a series configuration signal tape according to the invention. Smoke generator 46 comprises a heavy cardboard tube 48 which has a proximal end 49 and a distal end 50. It has been found in field testing that wire 66 has a tendency to be pulled out of tube 48 during use. This may cause smoke generator 46 to remain in the ground and not be pulled to the surface by excavation equipment. To prevent this possibility, it has been found useful to reinforce one or both ends of tube 48. Both proximal end 49 and distal end 50 of tube 48 are reinforced by having a smaller cylinder [52, 54] slid inside each of the tube ends [49, 50]. This construction is shown in FIGS. 8 and 9. Friction igniter 56 is positioned at distal end 50 of tube 48 and receives a free end of fuse 58. Ignition wire 62 has one end inserted within friction igniter 56 and the other end is attached to one end of ignition spring 60. The other end of ignition spring 60 is attached to wire cable 64. Wire cable 66 is looped through holes 68, 68′ in tube 48 and then passes through a hole in friction igniter 56 and then back through holes 68″ and 68″′ in tube 48 and is crimped to itself by crimp 70. Wire cables 64 and 66 may be made from 1/16 inch braided cable or any other suitable material. It should be noted that holes 68 and 68″′ and holes 68′ and 68″ are actually approximately 180° apart on the surface of tube 48 as shown in FIGS. 8 and 9. They are shown in FIG. 7 as being closer together than 180° to better illustrate the invention.

FIG. 8 shows a cross-section of the distal portion of the smoke generator shown in FIG. 7. The distal end 50 of generator 46 is shown in FIG. 8. Tube 48 (which may be a heavy cardboard tube) contains the smoke producing compound 74 in the central area thereof and tube 48 is reinforced by having cylinder 54 slid inside the distal end of tube 48. It has been found through field testing that wire 66 can be pulled completely out of tube 48 by the forces exerted by excavation equipment. Therefore, one or both ends of tube 48 are reinforced to prevent this. The relative sizes of tube 48 and cylinder 54 are selected such that cylinder 54 is tightly received within tube 48. Wire cable 66 is shown passing through hole 68′ and then passing through a hole [not shown] in igniter 56. Wire 66 then passes back through hole 68″ and returns to the proximal end 49 of tube 48. One end of fuse 58 is embedded within smoke producing compound 74 and the other end passes through a hole [not shown] in igniter 56 such that when igniter 56 is actuated, fuse 58 is lit and burns back to ignite smoke producing material 74. One end of ignition wire 62 is embedded within friction igniter 56 and the other end is attached to ignition spring 60. As noted below in § [0082], the purpose of ignition spring 60 is to provide more reliable ignition of friction igniter 56 in the operation of the signal tape. It has been found that a direct connection between ignition wire 62 and wire cable 64 is not the best system for producing reliable ignition of friction igniter 56. Thus ignition spring 60 was introduced into the system to provide for rapid and smooth withdrawal of ignition wire 62 from friction igniter 56, as explained below in § [0082].

FIG. 9 shows a cross-section of the proximal portion of the smoke generator shown in FIG. 7. The proximal end 49 of smoke generator 46 is shown in FIG. 9. Tube 48 contains the smoke producing material 74 and the proximal end 49 of tube 48 is reinforced by insertion of cylinder 52 therein in the same manner described above in § [0068] for the distal end 50 of tube 48. Wire 66 enters the proximal end of tube 48 and passes through hole 68 in cylinder 52 and tube 48 to the outside of tube 48. It then runs to the distal end 50 of tube 48 and passes through hole 68′ to the interior of tube 48 as shown in FIG. 8 and, after passing through friction igniter 56 passes back to the outside of tube 48 through hole 68″. Wire 66 then extends back to proximal end 49 of tube 48. There it passes through hole 68″′ to the inside of tube 48 and is crimped to itself by crimp 70.

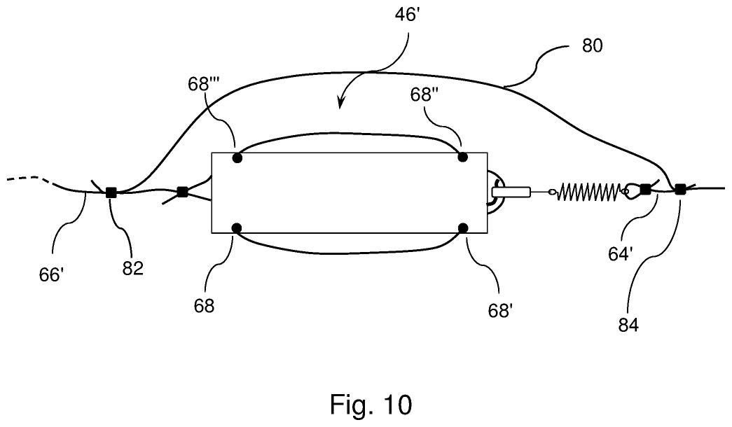

FIG. 10 shows a third embodiment of a smoke generator for the signal tape of the invention intended to be used in a series configuration of the signal tape. This embodiment is an improvement of the smoke generator 46 shown in FIG. 7. The only difference between the smoke generator 46′ shown in FIG. 10 and the smoke generator 46 shown in FIG. 7 is the introduction of bridge wire 80. In field testing it has been found that the embodiment shown in FIG. 7 works well if it is wire 66 that is snagged by the excavation equipment. Since wire 66 passes through reinforced tube 48 of the smoke generator 46 twice, the excavation equipment can pull the lit smoke generator out of the ground to the surface. It has been found that if it is wire 64 that is snagged by the excavation equipment, it is possible that smoke generator 46 will not be pulled to the surface. This is because ignition wire 62 is the only connection between wire 64 and smoke generator 46 and ignition wire 62 is often completely removed from friction igniter 56 when wire 64 is snagged by the excavation equipment. Thus, bridge wire 80 was provided and, as shown in FIG. 10, is crimped to wire 66′ by crimp 82 and also crimped to wire 64′ by crimp 84. The addition of bridge wire 80 helps to insure that smoke generator 46′ will be pulled to the surface by the excavation equipment no matter which wire is snagged by the excavation equipment. There is an additional advantage to having bridge wire 80 connected as shown in FIG. 10. Wires 64, 64′, 66 and 66′ are often made from braided steel cable, which is conductive. If bridge wire 80 is also conductive, it provides a continuous conductive path throughout the length of the signal tape, permitting the signal tape to be electronically detected by any conventional and known detecting device. It should be noted that holes 68 and 68″′ and holes 68′ and 68″ are actually approximately 180° apart on the surface of tube 48 as shown in FIGS. 8 and 9. They are shown in FIG. 10 as being closer together than 180° to better illustrate the invention. It is also to be noted that there has to be enough slack in bridge wire 80 such that the ignition wire can be pulled out of smoke generator 46′ when the wires 66′ or 64′ are snagged by excavation equipment.

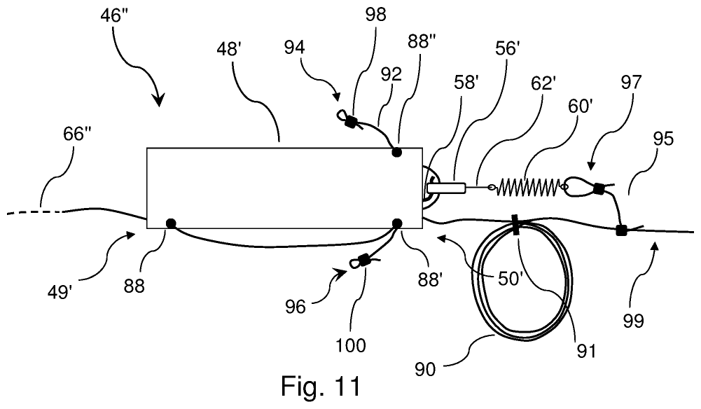

FIG. 11 shows a fourth embodiment of a smoke generator 46″ for the signal tape of the invention intended to be used in a series configuration of the signal tape. This embodiment is an improvement over that shown in FIG. 10. In field testing, it has been found that even the provision of bridge wire 80 sometimes fails to ensure that the lit smoke generator 46′ would be pulled to the surface by the excavation equipment. Breaks sometimes occurred at the crimped joints produced by crimps 82 and 84 causing smoke generator 46′ to be left in the ground. Thus, it was decided to make wire 66′ a continuous cable with no crimped joints and connecting all of the smoke generators in the series configuration of the signal tape. Continuous wire 66″ passes inside the distal end 49′ of tube 48′ and then through hole 88 to the outside of smoke generator 46″. The wire passes along the length of tube 48′ to the distal end 50′ of the smoke generator and then passes back inside tube 48′ through hole 88′. Approximately 3 feet of continuous wire 66″ is then looped together at 90 with zip tie 91 and then continuous wire 66″ continues on to the next smoke generator in the series string.

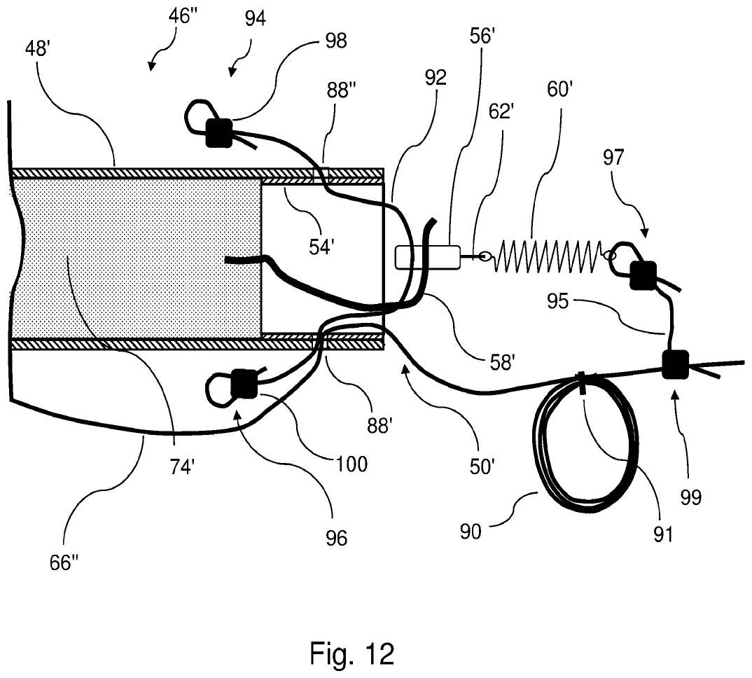

Since continuous wire 66″ does not travel up through the tube 48′ and out of the top hole 88″ in this configuration, some means must be provided to hold friction igniter 56′, ignition wire 62′ and ignition spring 60′ in position during operation of smoke generator 46″. This is accomplished by providing a separate wire 92 at the distal end 50′ of tube 48′ running from the top of smoke generator 46″ [as shown in FIG. 11] through hole 88″ and into the interior of tube 48′. The wire proceeds out of distal end 50′ and passes through a hole [not shown] in igniter 56′. It then passes back inside distal end 50′ and through hole 88′. Wire 92 is looped at each end 94 and 96 and crimped to itself by crimps 98, 100. It should be noted that holes 88′ and 88″ are actually approximately 180° apart on the surface of tube 48′ as shown in FIGS. 12. They are shown in FIG. 11 as being closer together than 180° to better illustrate the invention.

In the embodiment shown in FIG. 11, wire 66″ is now continuous and connects all of the smoke generators in the series configuration signal tape, therefore, wire 64′ as shown in FIG. 10 has been eliminated and there is nothing to attach to ignition spring 60′ to activate the smoke generator. Thus, wire 95 has been provided to pull on the ignition spring 60′ when the signal tape is struck by excavation equipment and to thus activate [ignite] smoke generator 46″. Wire 95 is attached to the free end of ignition spring 60′ at 97 and to wire 66″ at 99.

FIG. 12 shows a cross-section of the smoke generator 46″ shown in FIG. 11. The distal portion 50′ of smoke generator 46″ is shown with tube 48′, reinforcement cylinder 54′ and holes 88′ and 88″. Friction igniter 56′, fuse 58′, ignition wire 62′, ignition spring 60′, continuous wire 66″, cable loop 90, zip tie 91, wire 92, ends 94 and 96 and crimps 98 and 100 are all shown the same as they are in FIG. 11, just at a larger scale. Smoke producing material 74′ is shown in the interior of tube 48′. Wire 95 is also shown attaching the free end of ignition spring 60′ to the continuous wire 66″ as in FIG. 11.

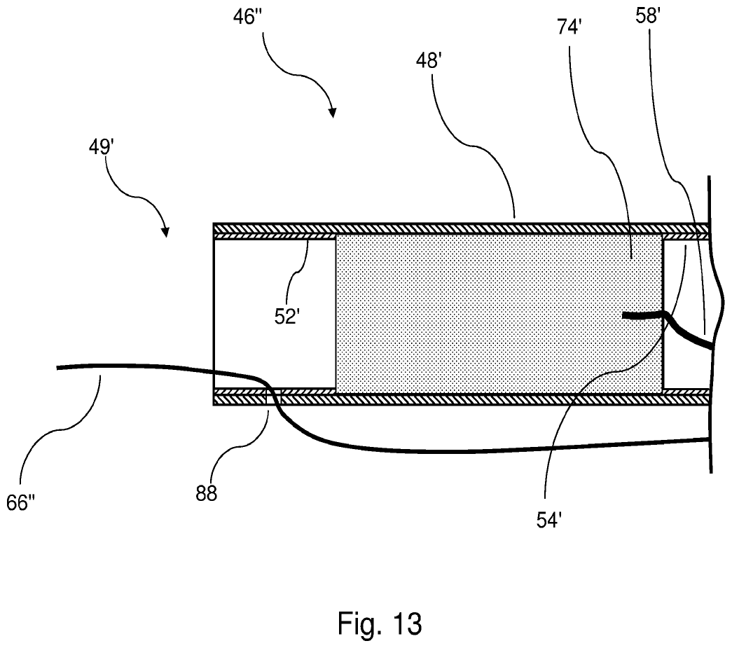

FIG. 13 shows a cross-section of the proximal portion 49′ of smoke generator 46″ shown in FIG. 11. Tube 48′, smoke producing material 74′, reinforcement cylinders 52′ and 54′ and fuse 58′ are all shown. Wire 66″ and hole 88, are also shown as they are shown in FIG. 11, except for the fact that hole 88 is shown in the bottom of tube 48′ and not exactly as shown in FIG. 11. As noted above for FIGS. 7, 10 and 11, the holes in tube 48 and 48′ are not shown in the figures as being diametrically opposed, yet they are diametrically opposed as shown in FIGS. 8, 9, 11A and 11B. This has been done to better illustrate the inventive smoke generator in FIGS. 7, 10 and 11.

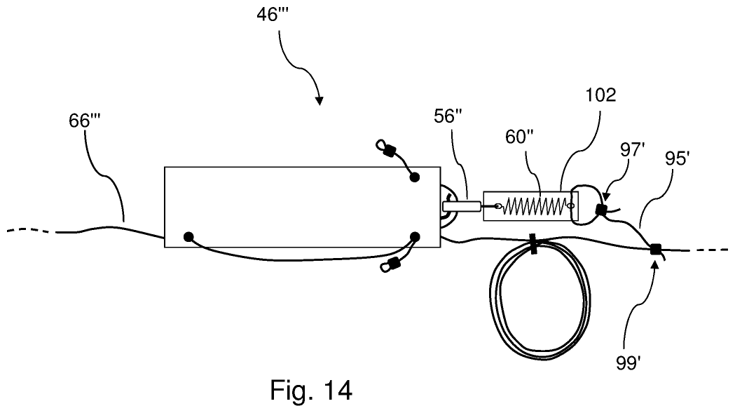

FIG. 14 shows a fifth embodiment of a smoke generator 46″′ for the signal tape of the invention intended to be used in a series configuration of the signal tape. This embodiment is an improvement of the smoke generator 46″ shown in FIG. 11. The only difference between the smoke generator 46″′ shown in FIG. 12 and the smoke generator 46″ shown in FIG. 11 is the introduction of protective cover 102. Wire 95′ which connects ignition spring 60″ to continuous wire 66″′ is made to have a slightly larger loop at 97′ to pass through holes [not shown] in protective cover 102 and also through the free end of ignition spring 60″. Wire 95 is crimped to continuous wire 66″′ at 99′.

In the embodiments shown in FIGS. 7, 8, 10, 11, 12 and 14 the fuse and the support wire for the friction igniter are shown as passing through different holes in the friction igniter. It is noted that this is not an absolute necessity since the support wire can be passed through the same hole in the igniter as the fuse.

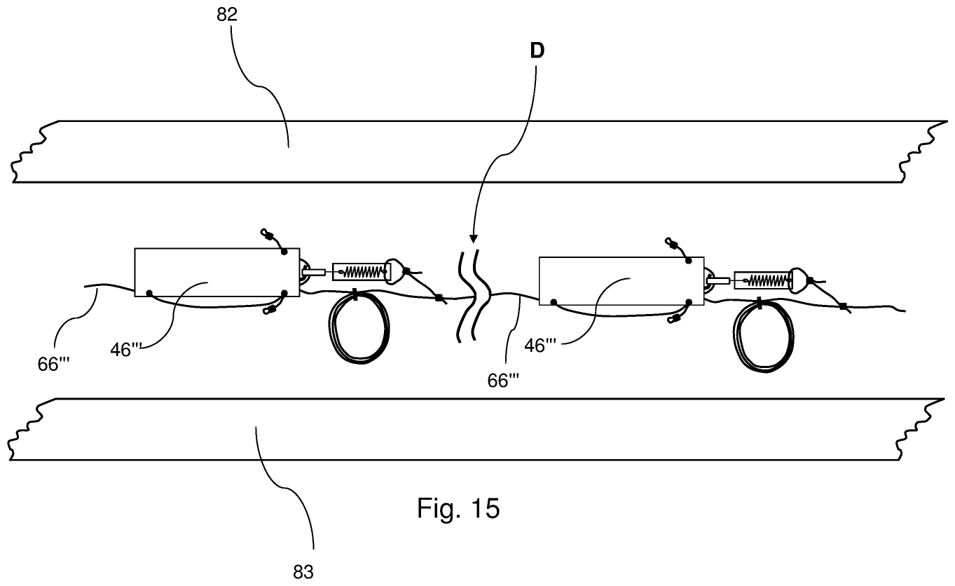

FIG. 15 shows a section of a series configuration signal tape according to this invention having multiple smoke generators identical to those shown in FIG. 14. A series of smoke generators 46″′ would be encapsulated with two layers of tape 82 and 83 to create the inventive signal tape. The two tapes 82, 83 are joined or sealed so as to fully encase and protect smoke generators 46″′, and all the components of the smoke generators. The tapes 82, 83 may be in the form of tape or any other form of casing which is long and thin but sufficiently robust to provide an environmental barrier as well as withstand the forces of installation. Smoke generators 46″′ may be aligned along the tape to allow for the tape to be rolled up for compact storage [as shown in FIG. 6] and installation in the same manner as marker tape is currently installed above a buried infrastructure. The tapes 82, 83 may be in the form of tape or any other form of casing which is long and thin but sufficiently robust to provide an environmental barrier as well as withstand the forces of installation. Tapes 82, 83 must be fully sealed and must provide an impermeable environmental barrier to water and other underground fluids and must provide a protective layer able to withstand the forces of installation and backfill during installation so that smoke generators 46″′ and all of their components remain fully protected and operable in situ. As shown by break marks D, smoke generators 46″′ are not as close together as is shown in FIG. 15 but would actually be separated by a distance previously shown in FIGS. 3-5 as Y which might vary from 3 to 8 feet or more as discussed above in § [0062] and § [0065].

In operation, a series of smoke generators would be encapsulated with two layers of tape to create the inventive signal tape and then buried underground near an underground infrastructure. This construction is illustrated in FIG. 15 and discussed above in § [0078] The two tapes 82, 83 are joined or sealed so as to fully encase and protect smoke generators 46″, ignition spring 60′, friction igniter 56′, ignition wire 62′ and wires 64 and 66. Smoke generators 46 may be aligned along the tape to allow for the tape to be rolled up for compact storage [as shown in FIG. 6] and installation in the same manner as marker tape is currently installed above a buried infrastructure. Tapes 82, 83 enable the system to be rolled up for transportation and unrolled for installation. Note that tapes 82, 83 shown in FIG. 15 above and below smoke generators 46″′ are laminated together or otherwise fixed together to fully encapsulate the smoke generators 46 and all connecting wires, etc. and other components of the signal tape.

The inventive signal tape is intended to be buried in close proximity to but not touching a pipeline or other buried infrastructure. It may run parallel to the buried infrastructure or be deployed in a serpentine pattern parallel to an above the buried infrastructure. In certain situations, it may be desirable to emplace two signal tapes above a buried pipeline or other infrastructure with one tape running parallel to and to the left of the buried infrastructure and the other tape running parallel to and to the right of the buried infrastructure.

The smoke generators are connected together with wire continuous wire cable 66″′ and spaced approximately 3 feet apart along the length of the signal tape although, as noted above, they could be closer or farther apart [for example, 8 feet]. For example a relatively shallow burial depth for the signal tape coupled with fairly loose soil might allow for a longer spacing of smoke generators. Conversely, a deeper burial depth coupled with fairly compact or rocky soil might necessitate a closer spacing for the smoke generators.

When the buried signal tape is struck by an excavation tool such as a backhoe bucket or scoop, continuous wire cable 66″′ is snagged by the excavation tool. Whether wire 66″′ is snagged at the distal end of smoke generator 46″′ by the excavation tool or snagged at the proximal end of the smoke generator, this will cause the ignition spring 60 to stretch and store energy. Ignition wire 62′ activates friction igniter 56′ through friction as ignition wire 62′ is pulled from friction igniter 56′. The spring constant for ignition spring 60′ is selected such that the initial stretching of ignition spring 60′ will not create enough force on ignition wire 62′ to cause ignition wire 62′ to move within friction igniter 56′. As motion of the excavator tool continues to exert more force on wire 66″′, ignition spring 60′ will continue to stretch and store energy until it exerts sufficient force upon ignition wire 62′ to overcome the inertia and friction of the ignition wire-igniter combination and ignition wire 62′ will start to move within friction igniter 56′. At this point the stored energy in ignition spring 60′ will cause ignition wire 62′ to rapidly and smoothly move out of friction igniter 56′ thus activating [igniting] friction igniter 56′ and lighting fuse 58′. Fuse 58′ will ignite the smoke producing material 74′ inside tube 48′. As the excavation tool continues to move to the ground surface, the now lit smoke generator 46″ will be pulled from the ground releasing a cloud of smoke at the surface thus providing a vivid signal of impending danger easily seen by the excavation equipment operator. Since the lit smoke generator may well be contained in the excavation bucket, it will appear to the operator that the smoke is coming from his own equipment. As noted above, this sort of signal cannot be misinterpreted and intuitively warns of danger.

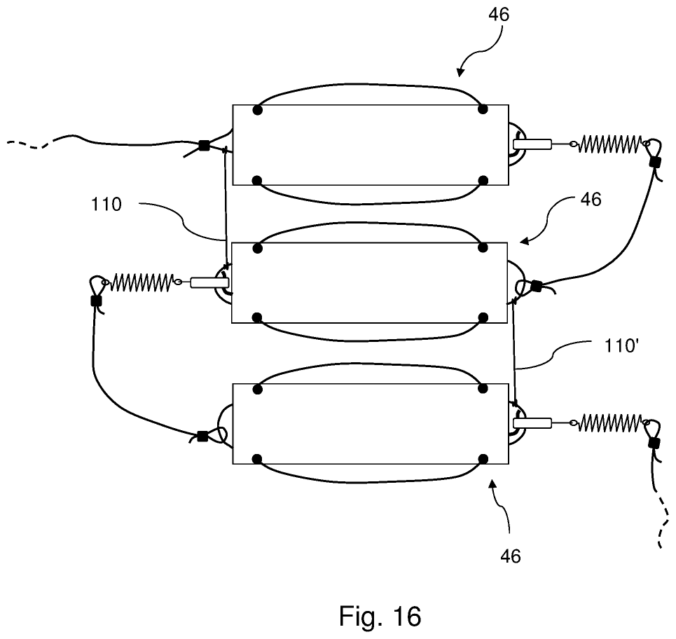

FIG. 16 shows a first embodiment of a smoke generator intended to be used in a ladder configuration signal tape. Smoke generators 46 are identical to those shown in FIG. 7. They are connected together by fishing line 110 and 110′ into a ladder configuration. The smoke generators would be emplaced between two tapes similar to tapes 82 and 83 as shown in FIG. 15. The spacing between the individual smoke generators 46 would be approximately 3 feet, although—as noted above—it could be greater [for example, 8 feet] or smaller, as desired.

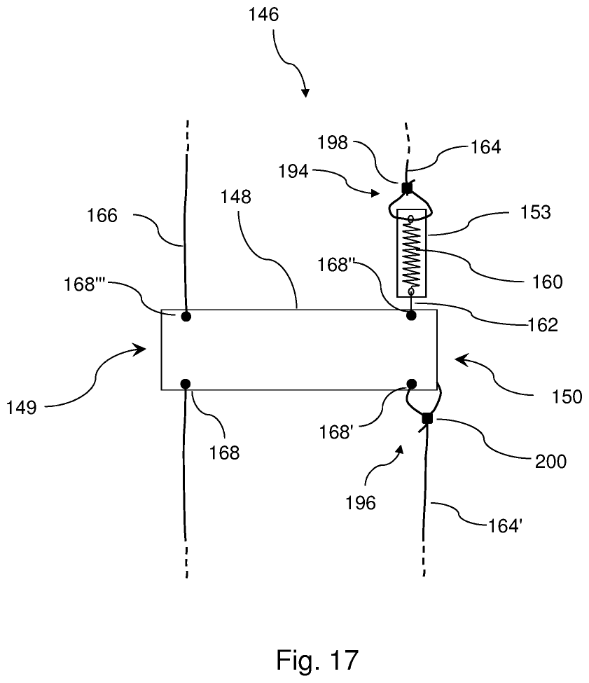

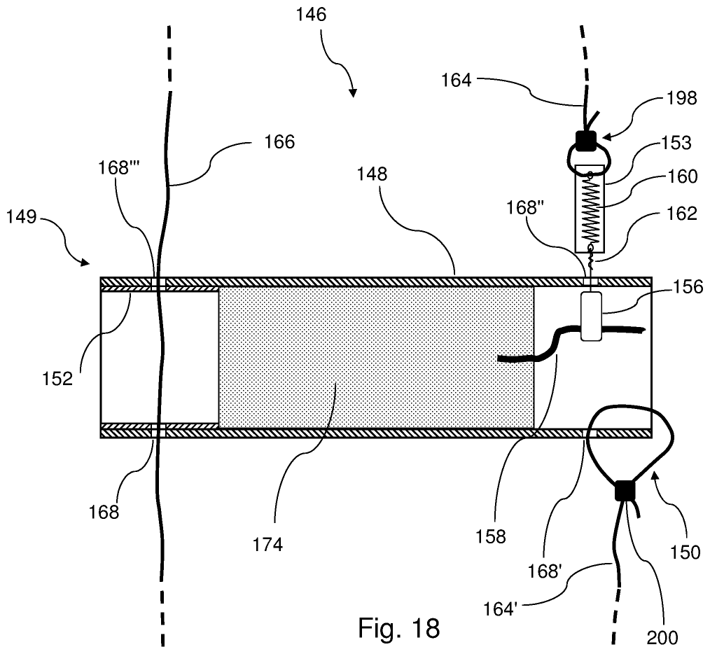

FIG. 17 shows a second embodiment of a smoke generator intended to be used in a ladder configuration signal tape. FIG. 18 shows a cross-sectional view of the smoke generator 146 of FIG. 17. These two figures will be described together with it being understood that some elements will be visible in one figure and not in the other. Smoke generator 146 comprise a tube 148 [which may be heavy cardboard] with proximal 149 and distal 150 ends. Tube 148 contains the smoke producing material 174. Holes 168 and 168″′ are bored through tube 148 near the proximal end of tube 148. Holes 168′ and 168″ are bored through tube 148 near the distal end thereof. Reinforcing cylinder 152 is emplaced within the proximal end 149 of tube 148. It has been found that, with this configuration, a reinforcing cylinder is not necessary on the distal end of tube 148. Holes 168 and 168″′ extend through tube 148 and reinforcing cylinder 152. As noted above for FIGS. 7, 10, 11, 14, 15 and 16, the holes in tube 148 are not shown in FIG. 17 as being diametrically opposed, yet they are diametrically opposed as shown in FIGS. 8, 9, 12, 13 and 18. This has been done to better illustrate the inventive smoke generator in FIGS. 7, 10, 11, 14, 15 and 16.

Continuous wire 166 passes through holes 168 and 168″′ at the proximal end 149 of smoke generator 146 and continues on to the next smoke generator in the string. Fuse 158 has one end thereof embedded within smoke producing material 174 and the other end threaded through a hole [not shown] in friction igniter 156. Friction igniter 156 is contained within the distal end 150 of tube 148 near hole 168″. Ignition wire 162 has one end thereof embedded within friction igniter 156 while the middle portion of ignition wire 162 passes outside tube 148 through hole 168″. The other end of ignition wire 162 is attached to one end of ignition spring 160. Ignition spring 160 is covered by protective cover 153. Wire 164 is looped through holes [not shown] in protective cover 153 and through the free end of ignition spring 160. Wire 164 is then crimped to itself at 194 by crimp 198. Wire 164′ passes through hole 168′ near the distal end of tube 148, passes outside of tube 148 and is looped back around and connected to itself at 196 by crimp 200.

FIG. 19 shows a section of a ladder configuration signal tape according to this invention having multiple smoke generators 146′ identical to smoke generator 146 shown in FIGS. 17 and 18. A series of smoke generators 146′ would be encapsulated with two layers of tape 282 and 283 to create the inventive signal tape. As shown in FIG. 19, the distance Y between smoke generators 146′ may be 3 feet, or greater than 3 feet or less, as discussed supra. The two tapes 282, 283 are joined or sealed so as to fully encase and protect smoke generators 146′, and all the components of the smoke generators. The tapes 282, 283 may be in the form of tape or any other form of casing which is long and thin but sufficiently robust to provide an environmental barrier as well as withstand the forces of installation. Smoke generators 146′ may be aligned along the tape to allow for the tape to be rolled up for compact storage [as shown in FIG. 6] and installation in the same manner as marker tape is currently installed above a buried infrastructure. Tapes 282, 283 must be fully sealed and must provide an impermeable environmental barrier to water and other underground fluids and must provide a protective layer able to withstand the forces of installation and backfill during installation so that smoke generators 146′ and all of their components remain fully protected and operable in situ.

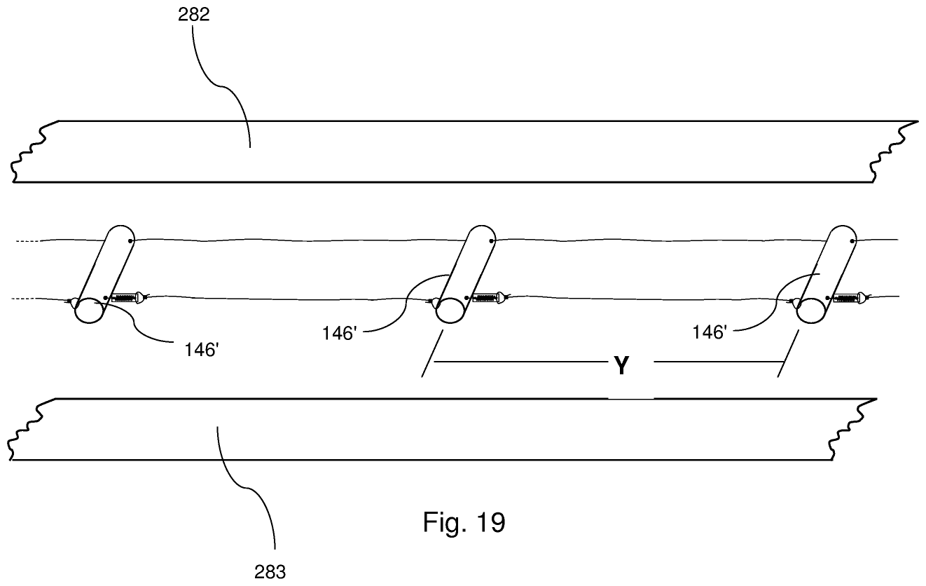

FIG. 20 shows two examples of a third embodiment 146″of the ladder configuration smoke generator connected together in a signal tape according to the invention. The only difference between smoke generators 146″ and the smoke generator 146 shown in FIGS. 17 and 18 is the addition of looped cable 190. It is noted that all of the wire cables shown in this application may be stranded steel cable of approximately 1/16 inch diameter. Looped cable 190 is approximately 3 feet of such cable looped and tied with a zip tie 191. Smoke generators 146″ are separated by a distance Y in the tape which, as discussed, supra, may be approximately 3 feet or more or less, as desired.

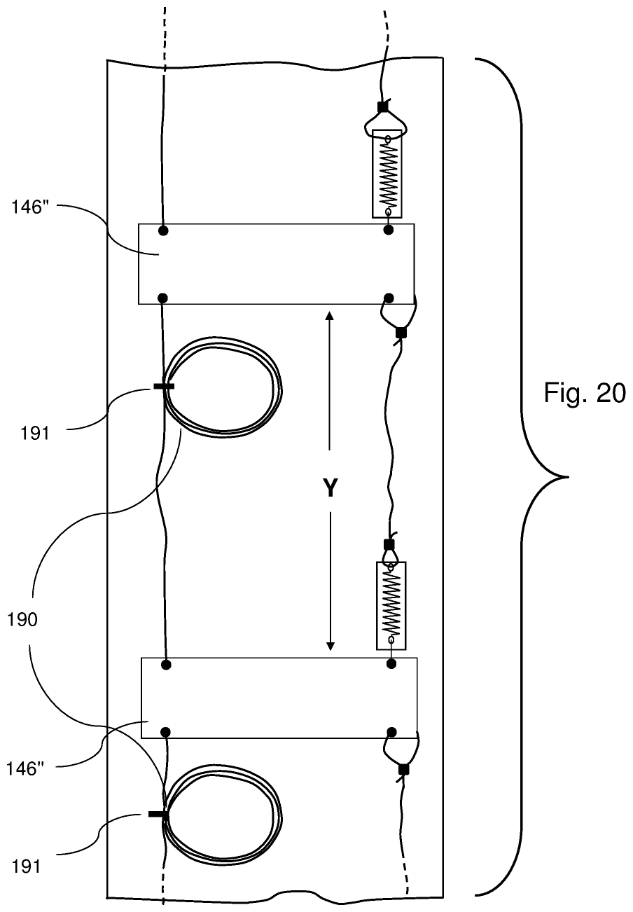

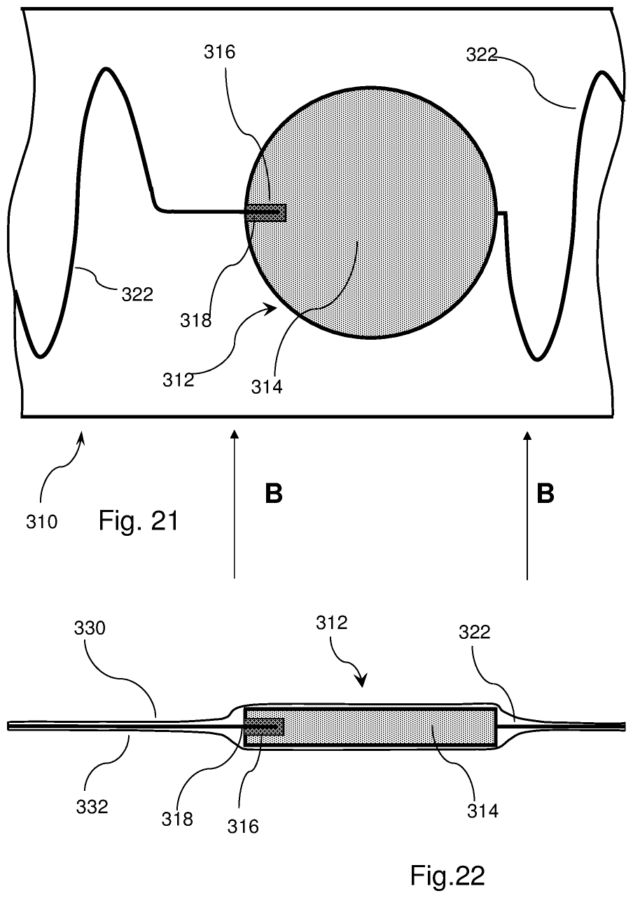

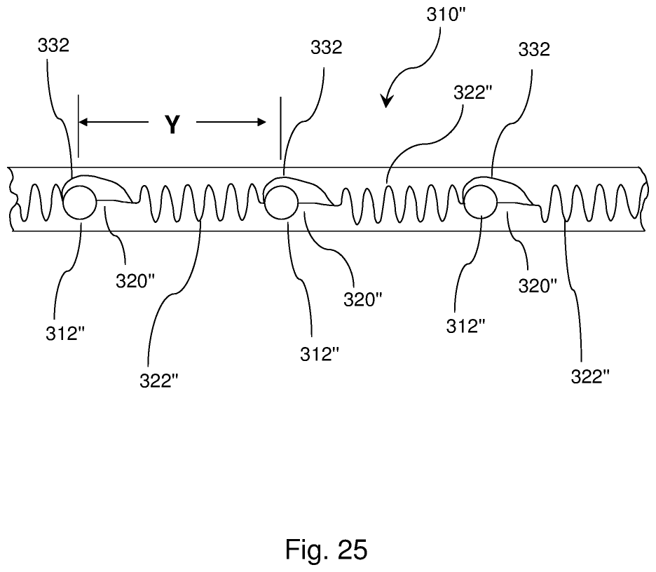

FIGS. 21-25 illustrate another embodiment of the signal tape shown in FIGS. 1-5, supra, but without the inclusion of ignition springs. FIGS. 21 and 22 will be described together and it should be understood that not all figure numerals are shown in each Figure. Signal tape 310 is essentially identical to signal tapes 10, 10′ and 10″ of FIGS. 1-5 but without ignition springs 20 and 20″. Signal tape 310 has smoke generators 312 therein containing a conventional smoke generating composition 314 with an igniter portion 316 and an igniter wire 318 positioned in igniter portion 316. Elements 310, 312, 314, 316 and 318 are essentially identical to elements 10, 12, 14, 16 and 18 of FIGS. 1-5. Connecting wire 322 is essentially identical to connecting wire 22 of FIGS. 1-5 except that connecting wire 322 is attached [at the left side of smoke generator 312] directly to the ignition wire 318 instead of being attached to the ignition spring. Signal tape 310 is completed by thermoplastic sheets 330 and 332 which in a known manner form an environmental barrier for the other components of signal tape 310. Sheets 330 and 332 may be made from known materials with good resistance to the environment found underground. For example, these known materials are as described in U.S. Pat. No. 3,633,533 issued in 1972 to Gordon H. Allen et al. [hereinafter Allen '533]. Allen '533 disclosed an early example of marker tape comprising a thin plastic film which may be made, for example, of polyethylene or polypropylene or polyvinylidene chloride [e.g. Saran™] or a fluorocarbon. Sheets 330 and 332 may be comprised of the foregoing materials and further comprise a film which may have a thickness of about 0.001 to 0.002 inch.

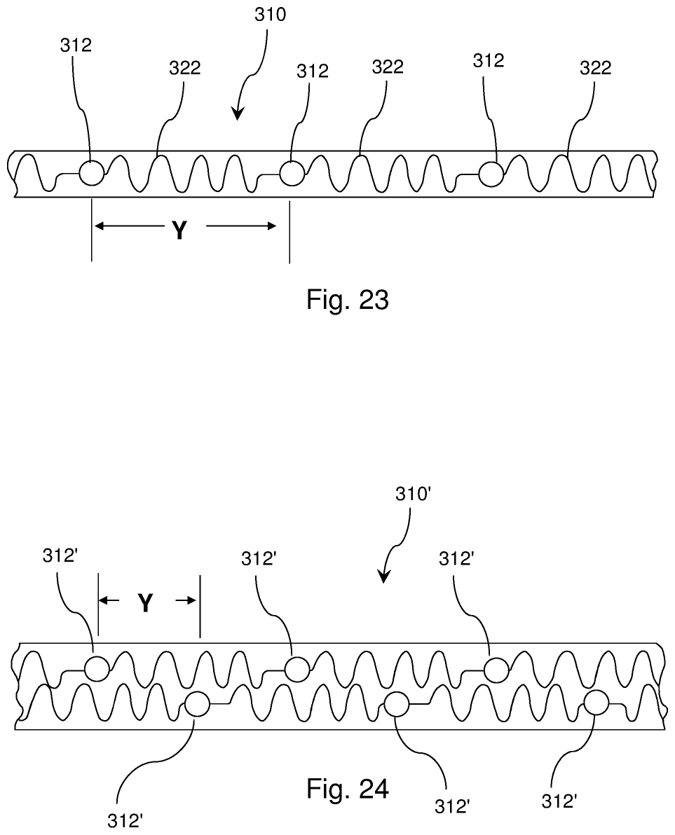

FIGS. 23-25 show signal tapes that are essentially identical to those of FIGS. 3-5 except that signal tapes 310, 310′ and 310″ do not have any ignition springs contained therein. Similar numbers in FIGS. 23-25 to those in FIGS. 1-5 show the same elements. For example, smoke generators 312 of FIGS. 23-25 are essentially identical to smoke generator 12 of FIGS. 1-5.

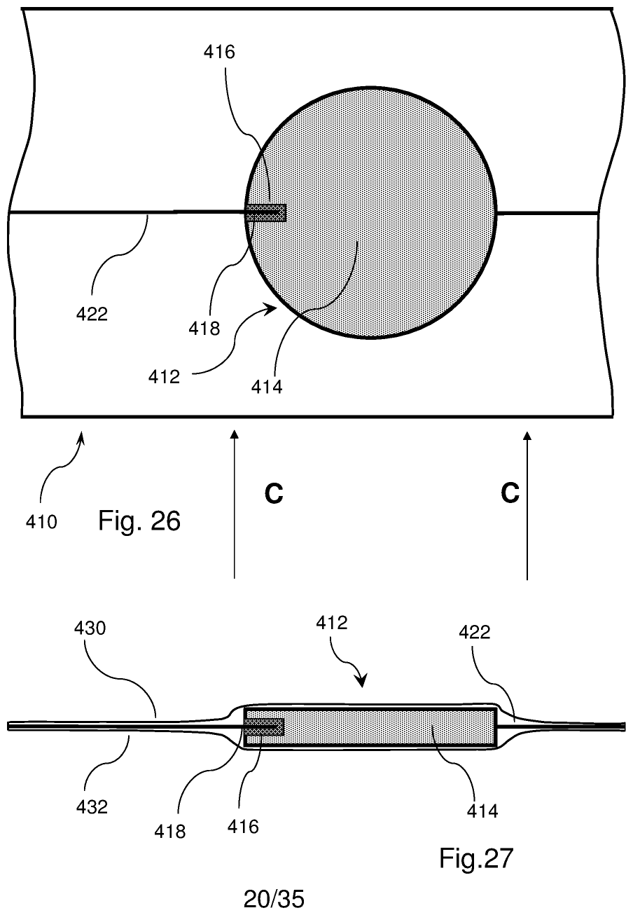

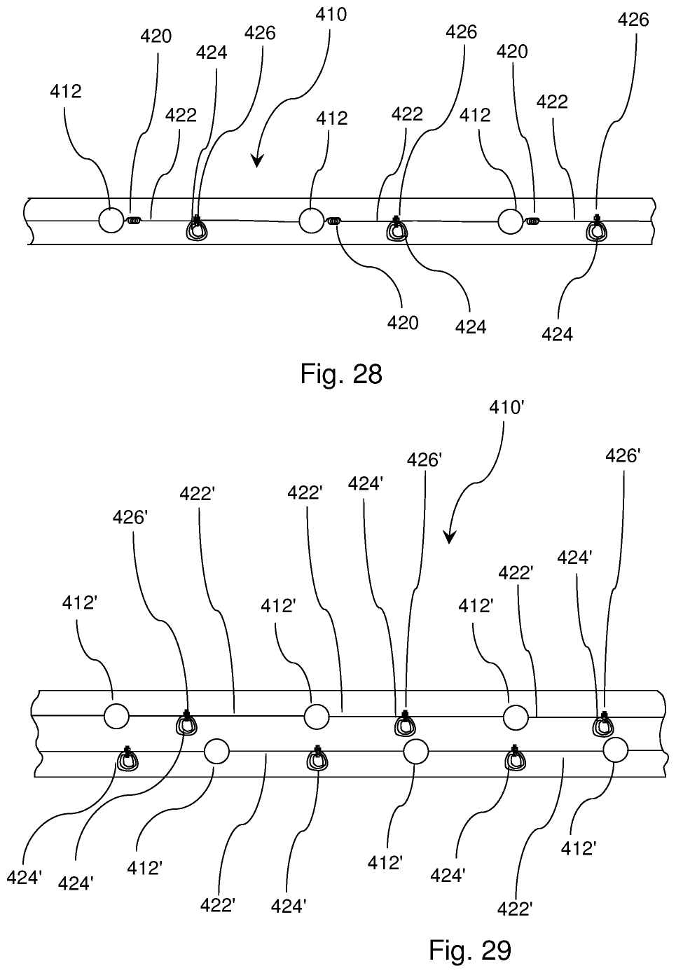

FIGS. 26-30 illustrate another embodiment of the signal tape shown in FIGS. 1-5, supra, but without the inclusion of ignition springs. It should be understood that the signal tape of this embodiment can utilize ignition springs as shown in FIGS. 1-5 and as shown in FIG. 28 or the ignition springs may be omitted as shown in FIGS. 26, 27 29 and 30. In addition, the connecting wires 422, 422′ and 422″ unlike the showings of FIGS. 1-5 are not arrayed in a sinusoidal configuration in FIGS. 26-30 but are essentially straight. FIGS. 26 and 27 will be described together and it should be understood that not all figure numerals are shown in each Figure. Signal tape 310 is essentially identical to signal tapes 10, 10′ and 10″ of FIGS. 1-5 but without ignition springs 20 and 20″. Signal tape 410 has smoke generators 412 therein containing a conventional smoke generating composition 14 with an igniter portion 416 and an igniter wire 418 positioned in igniter portion 416. Elements 410, 412, 414, 416 and 418 are essentially identical to elements 10, 12, 14, 16 and 18 of FIGS. 1-5. Connecting wire 422 is essentially identical to connecting wire 22 of FIGS. 1-5 except that connecting wire 422 is attached [at the left side of smoke generator 312] directly to the ignition wire 318 instead of being attached to the ignition spring and connecting wires 422, 422′ and 422″ are straight and do not have the sinusoidal configuration shown in FIGS. 1-5 . Signal tape 410 is completed by thermoplastic sheets 430 and 432 which in a known manner form an environmental barrier for the other components of signal tape 410. Sheets 430 and 432 may be made from known materials with good resistance to the environment found underground. For example, these known materials are as described in U.S. Pat. No. 3,633,533 issued in 1972 to Gordon H. Allen et al. [hereinafter Allen '533]. Allen '533 disclosed an early example of marker tape comprising a thin plastic film which may be made, for example, of polyethylene or polypropylene or polyvinylidene chloride [e.g. Saran™] or a fluorocarbon. Sheets 430 and 432 may be comprised of the foregoing materials and further comprise a film which may have a thickness of about 0.001 to 0.002 inch.

FIG. 28 illustrates an embodiment of the inventive signal tape very similar to that shown in FIG. 3 except that signal tape 410 does not have connecting wire 422 arrayed in sinusoidal configuration. Signal tape 410 does have ignition springs 420 as shown similar to ignition springs 20 shown in FIGS. 1-5. As noted above, connecting wires 422 are essentially straight and have collected bundles of extra wire 424 attached between smoke generators 412. Bundles of extra wire 424 are attached to connecting wires 422 by cable ties 426.

FIG. 29 illustrates an embodiment of the inventive signal tape very similar to that shown in FIG. 4 except that signal tape 410′ does not have ignition springs and the connecting wires 422′ run straight between smoke generators 412′. In addition, extra wire 424′ is bundled and attached to connecting wires 422′ by cable ties 426′.

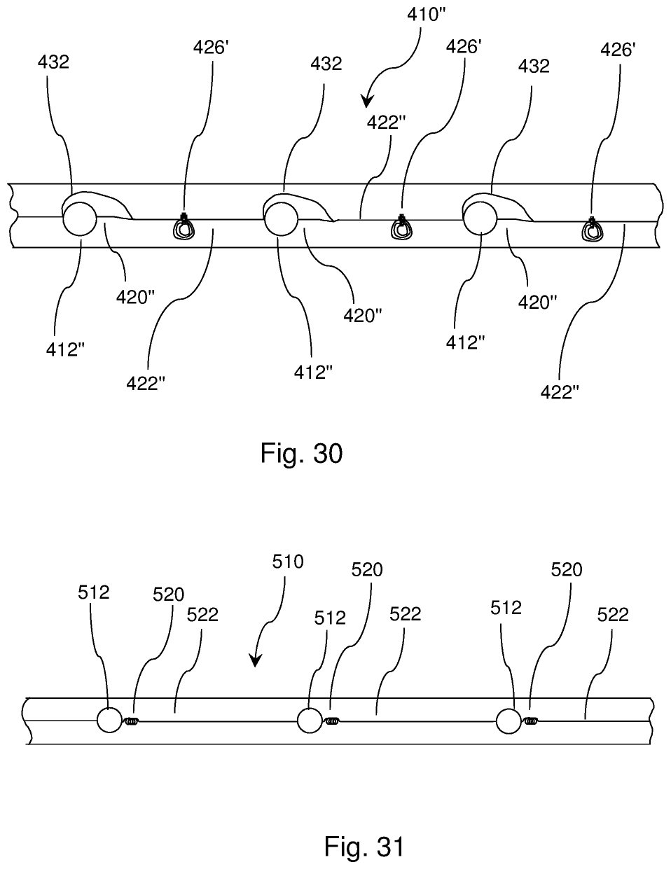

FIG. 30 illustrates an embodiment of the inventive signal tape very similar to that shown in FIG. 5 except that signal tape 410″ does not have ignition springs and the connecting wires 422″ run straight between smoke generators 412″. In addition, extra wire 424″ is bundled and attached to connecting wires 422″ by cable ties 426″.

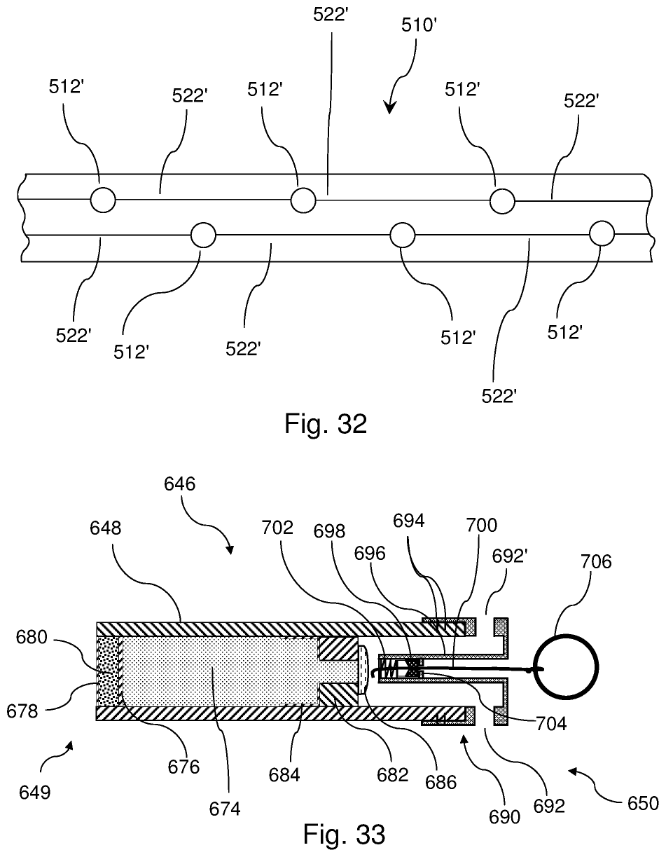

FIGS. 31 and 32 illustrate an embodiment of the inventive signal tape very similar to that shown in FIGS. 3 and 4 except that signal tape 410″ does not have ignition springs and the connecting wires 422″ run straight between smoke generators 412″. No extra wire is bundled and attached to connecting wires 422″ in this embodiment. However, it should be noted that the signal tape of this embodiment may or may not utilize ignition springs. Optional ignition springs 520 are shown in signal tape 510 and not show in signal tape 510′.

FIGS. 33-38 illustrate another embodiment of a smoke generator suitable for use with the inventive signal tape. It should be noted that this smoke generator has a number of common or similar elements to those of smoke generator 46 shown in FIGS. 7-9. Smoke generator 646 shown in FIG. 33 comprises a tube 648 which may be made from heavy cardboard. Tube 648 is filled with a known smoke producing compound 674.

With regard to FIG. 33, tube 648 is closed off at the proximal end 649 by cardboard or metal disks 676, 678 tightly wedged or otherwise fastened to the interior of tube 648. Earth or sand or a similar inert material 680 is contained within the space between disks 676 and 678 to help contain and control the reaction of smoke producing compound 674. Annular plug 682 is also mounted in the interior of tube 648 in any known manner to help contain smoke producing compound 674 and to provide a seat for ignition button 686. Annular sleeve 684 is attached to the interior of tube 648 in any known manner to provide support to annular plug 682. Sleeve 684 and plug 682 may be attached to tube 648 using adhesive or any appropriate mechanical fasteners. Cap 690 is attached to the distal end 650 of tube 648. Cap 690 is made of metal, heat-resistant thermoplastic or any other suitable material and serves to control and channel the release of the smoke products produced by the reaction of smoke producing compound 674 and also serves to ignite smoke generator 646 in a manner that will be described below. Cap 690 has two smoke releasing holes 692, 692′ approximately 180° apart although more such smoke releasing holes [or fewer] may be used, as desired. Cap 690 may be secured to tube 648 by pins 694 as shown, by teeth [not shown in the figures] formed internally of cap 690 which tightly grasp tube 648 or by adhesive [also not shown]. Cap 690 may also be secured to tube 648 in any other conventional manner, as desired.

Cap 690 carries on the interior thereof ignition tube 696 which contains the ignition device for smoke generator 646. Igniter tube 696 carries igniter striker 698 which receives igniter wire 700. Ring 706 is attached to the right hand end of igniter wire 700. Igniter striker 698 is secured within igniter tube 696 through the interaction of spring 702 and annular disk 704. Spring 702 is secured within the rear end of igniter tube 696 and biases igniter striker 698 towards and against annular disk 704. Ignition wire 700 is threaded through a hole [not shown] in igniter striker 698 such that when ignition wire 700 is pulled to the right in FIG. 33 by ring 706, a shower of sparks is created. This shower of sparks falls on ignition button 686 which then ignites and, in turn, ignites smoke producing composition 674. The smoke thus produced by the reaction of smoke producing composition 674 rushes out through smoke releasing holes 692, 692′ because the ignition button 686 which was sealing the hole [not numbered in the figures] in annular disk 682 burns up upon ignition by the shower of sparks—thus opening the afore-mentioned hole in annular disk 682.

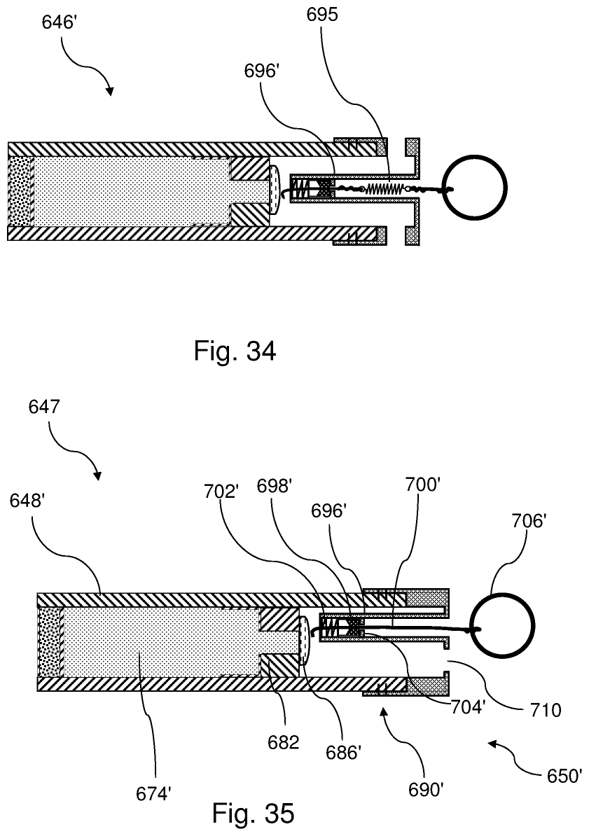

FIG. 34 shows another embodiment 646′ of the smoke generator of the invention. Smoke generator 646′ is essentially identical to smoke generator 646 except that it carries an ignition spring within igniter tube 696′. Ignition spring 695 functions in the same manner as ignition spring 60″ of smoke generator 46″′ as shown in FIGS. 14 and 15 and as described in § [0083], supra.

FIG. 35 shows another embodiment of a smoke generator suitable for use with the inventive signal tape. Smoke generator 647 is identical to smoke generator 646 [as shown in FIG. 33] except for the cap 690′. Smoke generator 647 comprises tube 648′, smoke producing composition 674′, annular plug 682′ and ignition button 686′ all substantially identical to the similarly numbered elements in smoke generator 646 of FIG. 33. Cap 690′ differs from cap 690 in that cap 690′ has a single smoke releasing hole 710 mounted at the distal end 650′ of cap 690′. Cap 690′ carries on the interior thereof igniter tube 696′ which contains the ignition device for smoke generator 647. Cap 690′ also differs from cap 690 in that igniter tube 696′ is offset from the center of cap 690′ instead of being mounted in the center of cap 690 as shown in FIG. 33. The reason for this offset construction is to make room for smoke releasing hole 710 in the top portion of cap 690′. Even though a single smoke releasing hole 710 is shown in FIG. 35, it is obvious that more than one smoke releasing hole 710 may be placed in the top portion of cap 690′, if desired. Igniter tube 696′ carries igniter striker 698′ which receives igniter wire 700′. Ring 706′ is attached to the right hand end of igniter wire 700′. Igniter striker 698′ is secured within igniter tube 696′ through the interaction of spring 702′ and annular disk 704′. Spring 702′ is secured within the rear end of igniter tube 696′ and biases igniter striker 698′ towards and against annular disk 704′. Ignition wire 700′ is threaded through a hole [not shown] in igniter striker 698′ such that when ignition wire 700′ is pulled to the right in FIG. 35 by ring 706′, a shower of sparks is created. This shower of sparks falls on ignition button 686′ which then ignites and, in turn, ignites smoke producing composition 674′. The smoke thus produced by the reaction of smoke producing composition 674′ rushes out through smoke releasing holes 710 because the ignition button 686′ which was sealing the hole [not numbered in the figures] in annular disk 682′ burns up upon ignition by the shower of sparks—thus opening the afore-mentioned hole in annular disk 682′.

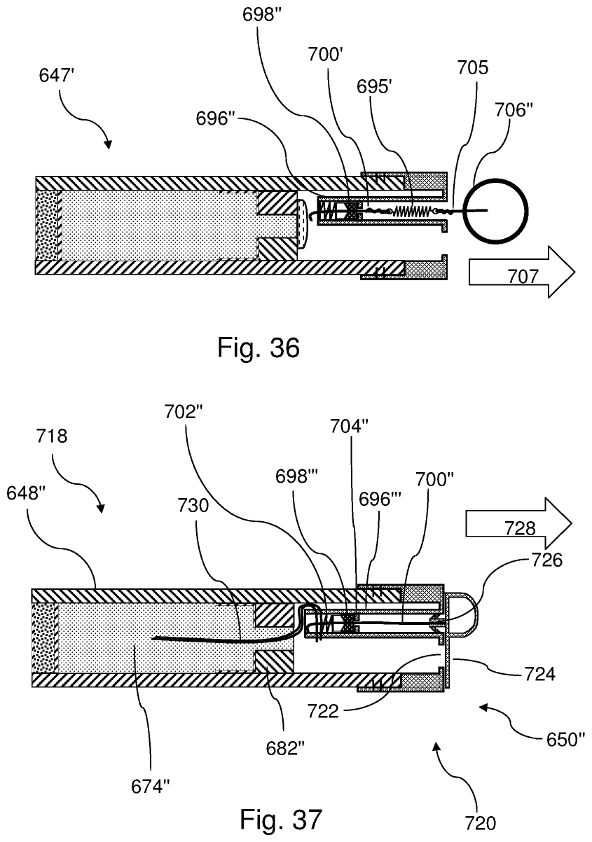

FIG. 36 shows another embodiment 647′ of the smoke generator of the invention. Smoke generator 647′ is essentially identical to smoke generator 647 except that it carries an ignition spring 695′ within igniter tube 696″. Ignition spring 695′ is attached at the proximal end to igniter wire 700′ and at its distal end to wire 705 which is connected to ring 706″. When ring 706″ is pulled in the direction of arrow 707, spring 695′ stores energy to a certain point and then releases that stored energy by giving a smart pull on igniter wire 700′ thus moving it through igniter striker 698″ and causing ignition of smoke generator 647′ in the same manner as ignition spring 60″ of smoke generator 46″′ as shown in FIGS. 14 and 15 and as described in § [0083], supra.

FIG. 37 shows another embodiment of a smoke generator suitable for use with the inventive signal tape. Smoke generator 718 is similar to smoke generator 647 and smoke generator 647′ [as shown in FIGS. 35 and 36]. Smoke generator 718 has a different cap 720 than cap 690′ of smoke generator 647. In addition, smoke generator 718 does not have an igniter button 686′ as smoke generator 647 does. Smoke generator 718 comprises tube 648″, smoke producing composition 674″, and annular plug 682″ all substantially identical to the similarly numbered elements in smoke generator 647 of FIG. 34. Cap 720 is similar to cap 690′ in that cap 720 also has a single smoke releasing hole 722 mounted at the distal end 650″ of cap 720. Cap 720 carries on the interior thereof igniter tube 696″′ which contains the ignition device for smoke generator 718 in a manner very similar to that shown in FIGS. 35 and 36. Cap 720 is similar to cap 690′ in that igniter tube 696″′ is also offset from the center of cap 720 instead of being mounted in the center of cap 690 as shown in FIG. 33. The reason for this offset construction is to make room for smoke releasing hole 722 in the top portion of cap 720. Even though a single smoke releasing hole 772 is shown in FIG. 37, it is obvious that more than one smoke releasing hole 722 may be placed in the top portion of cap 720, if desired.

Igniter tube 696″′ carries igniter striker 698″′ which receives igniter wire 700″ in a hole not shown in the drawings. D-ring closure disk 724 is removably mounted to the distal end 650″ of cap 720 and mounted in such a manner as to close smoke releasing hole 722. D-ring closure disk 724 also receives the distal end of ignition wire 700″ in such a manner that, when D-ring closure disk 724 is pulled in the direction of arrow 728, ignition wire 700″ is pulled through the aforementioned hole in igniter striker 698″′ causing a shower of sparks as described above in § [0097] in relation to the operation of smoke generator 646. However, in smoke generator 718, since ignition button 686 is not present—the shower of sparks falls upon and ignites two fuses 730 secured in igniter tube 696″′ as shown in FIG. 37. Insert portion 726 of D-ring closure disk 724 is releasably mounted, as shown in FIG. 37, within igniter tube 696″′ such that D-ring closure disk 724 is secured to distal end 650″ of cap 720 and normally closes smoke releasing hole 722. When sufficient force is exerted on D-ring closure disk 724 in the direction of arrow 728, D-ring closure disk 724 will be pulled out of igniter striker 698″′—pulling igniter wire 700″ through the hole in igniter striker 698″′ and thus causing the aforementioned shower of sparks to occur and causing the ignition of fuses 730. Igniter striker 698″′ is secured within igniter tube 696″′ through the interaction of spring 702″ and annular disk 704″. Spring 702″ is secured within the rear end of igniter tube 696″′ and biases igniter striker 698″′ towards and against annular disk 704″.

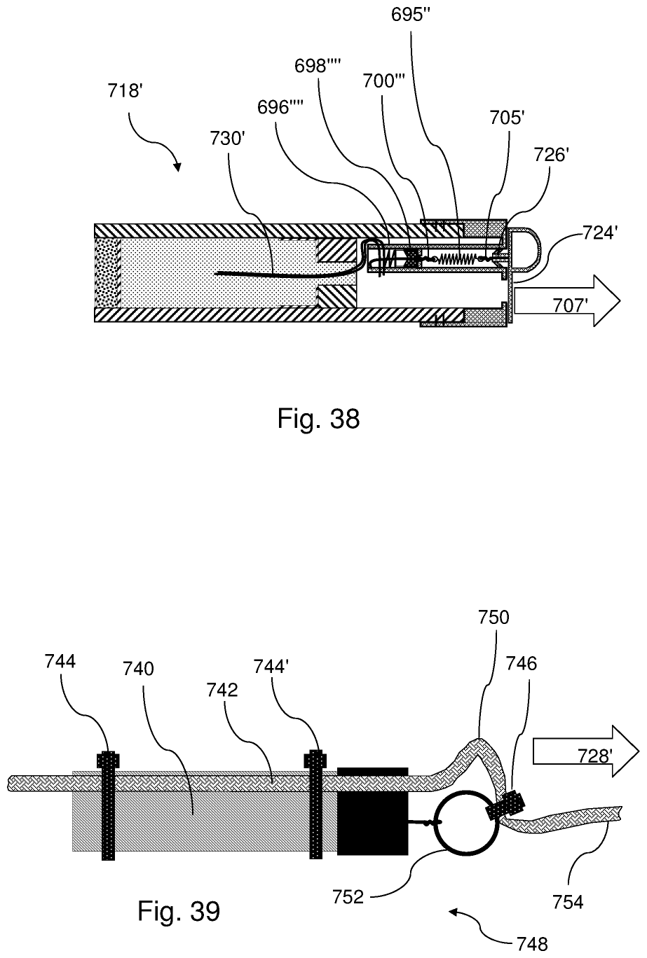

FIG. 38 shows another embodiment 718′ of the smoke generator of the invention. Smoke generator 718′ is essentially identical to smoke generator 718 except that it carries an ignition spring 695″ within igniter tube 696″″. Ignition spring 695′ is attached at the proximal end to igniter wire 700″′ and at its distal end to wire 705′ which is connected insert portion 726′ of closure disk 724′. When closure disk 724′ is pulled in the direction of arrow 707′, spring 695″ stores energy up to a certain point and then releases that stored energy by giving a smart pull on igniter wire 700″′ thus moving it through igniter striker 698″″ and causing ignition of smoke generator 718′ in the same manner as ignition spring 60″ of smoke generator 46″′ as shown in FIGS. 14 and 15 and as described in § [0083], supra.

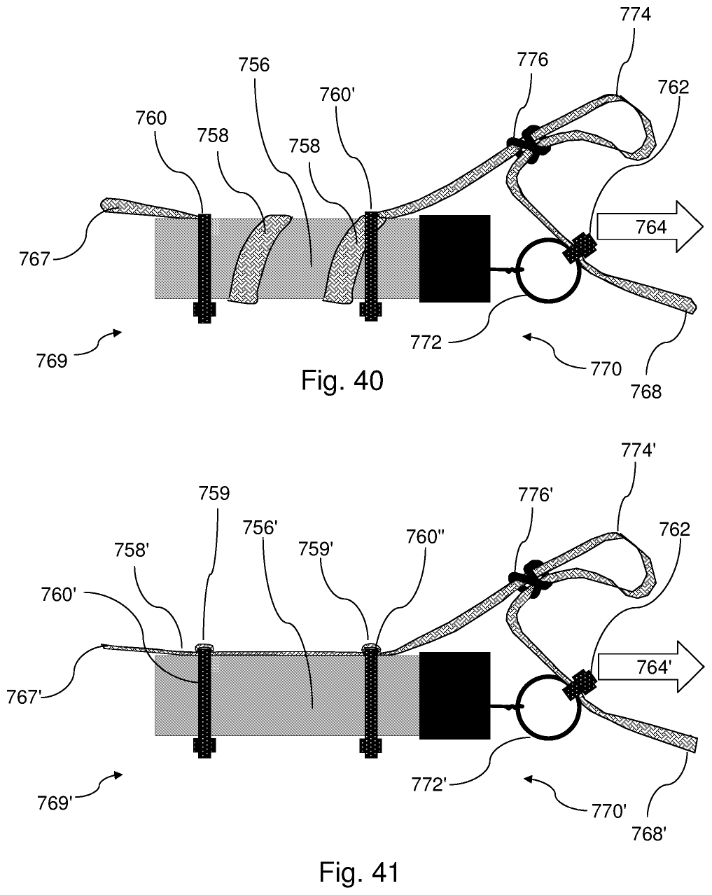

FIG. 39 shows one manner of attaching a smoke generator 740 which may be identical to any of smoke generators 646, 646′, 647, 647′, 718 or 718′ shown in FIGS. 33-38 to a woven fabric core material 742 in the form of an elongated tape. It has been determined through field testing that a fabric core material 742 made from woven polyester tape with a tensile strength from 100 lb_{f} [approximately 445 Newtons] to 2000 lb_{f} [approximately 8,900 Newtons] works quite well with the inventive signal tape. It has also been found through field testing that fabric core material 742 made of aramid synthetic fiber having a tensile strength of approximately 3000 lb_{f} [approximately 13,345 Newtons] also works quite well with the inventive signal tape. A shock cord with a 400 lb_{f} [approximately 1.780 Newtons] tensile strength will also work well as the core material. It should be noted that fabric core material 742 simply runs along the outer surface of the body of smoke generator 740 and is tightly attached to smoke generator 740 by two conventional thermoplastic cable ties 744 and 744′. Fabric core material 742 extends beyond distal end 748 of smoke generator 740 and is looped with extra material as shown at 750 and then tightly attached to ring 752 by conventional cable tie 746. In this manner a force pulling in the direction of arrow 728′ on distal end 754 of fabric core material 742 will cause ring 752 to be pulled to the right thus igniting smoke generator 740 as discussed above in relation to the smoke generators shown in FIGS. 33-38.

FIG. 40 shows another manner of attaching a smoke generator 756 which may be identical to any of smoke generators 646, 646′, 647, 647′, 718 or 718′ shown in FIGS. 33-38 to a woven fabric core material 758 in the form of an elongated tape. It has been determined through field testing that a fabric core material 758 made from woven polyester tape with a tensile strength from 100 lb_{f} [approximately 445 Newtons] to 2000 lb_{f} [approximately 8,900 Newtons] works quite well with the inventive signal tape. It has also been found through field testing that fabric core material 758 made of aramid synthetic fiber having a tensile strength of approximately 3000 lb_{f} [approximately 13,345 Newtons] also works quite well with the inventive signal tape. The proximal end 767 of fabric core material 758 approaches the proximal end 769 of smoke generator 756 and is wrapped around the circumference of smoke generator 756 as show in FIG. 40. Fabric core material 758 is tightly attached to smoke generator 756 by conventional cable ties 760, 760′ . Fabric core material 758 then extends to the distal end 770 of smoke generator 756 and is gathered into a loop of extra core material 774 by elastic band 776 and then fabric core material 758 proceeds to and is tightly attached to ring 772 by conventional cable tie 762. In this manner a force pulling in the direction of arrow 764 on distal end 768 of fabric core material 758 will cause ring 772 to be pulled to the right thus igniting smoke generator 756 as discussed above in relation to the smoke generators shown in FIGS. 33-38. It is to be understood that smoke generator 756 may or may not have an igniter spring as shown and discussed supra with respect to the smoke generators shown in FIGS. 33-38. The choice of whether or not to use an igniter spring is optional and will depend to a certain extent on field conditions encountered where the inventive signal tape is utilized.

FIG. 41 shows another manner of attaching a smoke generator 756′ which may be identical to any of smoke generators 646, 646′, 647, 647′, 718 or 718′ shown in FIGS. 33-38 to a woven fabric core material 758′ in the form of an elongated tape. The proximal end of smoke generator 756′ is shown by the arrow 769′ and the distal end of smoke generator 756′ is shown by arrow 770′. The proximal end 767′ of fabric core material 758′ approaches the proximal end of smoke generator 756′ and lies on the top portion of smoke generator 756′. It then proceeds under cable tie 760′ and then is looped back over cable tie 760′ in the direction of proximal end 769′ of smoke generator 756′ as shown at 759 in FIG. 41. Fabric core material 758′ then is looped back underneath cable tie 760′ and extends towards the distal end 770′ of smoke generator 756′ all the while lying on the top portion of smoke generator 756′ as shown in FIG. 41. As fabric core material approaches the distal end 770′of smoke generator 756′ it passes underneath cable tie 760″ and is looped back over the top of cable tie 760″ and then back underneath cable tie 760″ and towards the distal end 770′ of smoke generator 756′ as before and as shown in FIG. 41. Fabric core material 758′ then extends to the distal end 770′ of smoke generator 756′ and is gathered into a loop of extra core material 774′ by elastic band 776′ and then fabric core material 758′ proceeds to and is tightly attached to ring 772′ by conventional cable tie 762′. In this manner a force pulling in the direction of arrow 764′ on distal end 768′ of fabric core material 758′ will cause ring 772′ to be pulled to the right thus igniting smoke generator 756′ as discussed above in relation to the smoke generators shown in FIGS. 33-38. Smoke generator 756′ may or may not have an igniter spring as discussed above in § [0106].

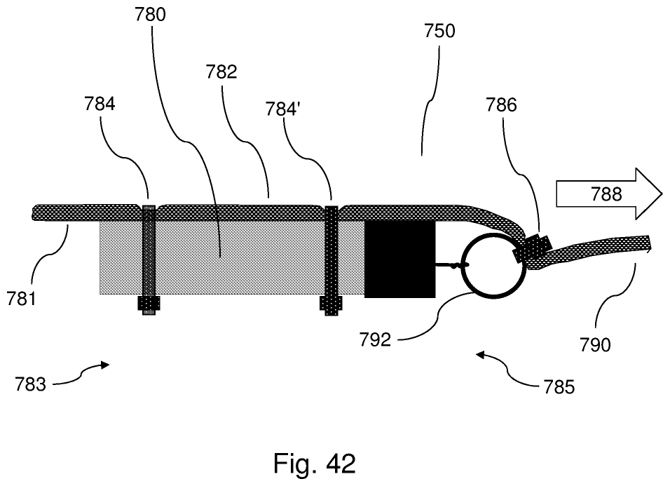

FIG. 42 shows another manner of attaching a smoke generator 780 which may be identical to any of smoke generators 646, 646′, 647, 647′, 718 or 718′ shown in FIGS. 33-38 to a shock cord core material 782. The proximal end of smoke generator 780 is shown by the arrow 783 and the distal end of smoke generator 780 is shown by arrow 785. The proximal end 781 of shock cord core material 782 approaches the proximal end of smoke generator 780 and lies on the top portion of smoke generator 780. It then proceeds to the distal end 785 of smoke generator 780 along the top of smoke generator 780 as shown in FIG. 42. Shock cord core material 782 is tightly clamped to smoke generator 780 by cable ties 784. 784′ and proceeds beyond the distal end 785 of smoke generator 780. Shock cord core material 782 is tightly clamped to ring 792 by cable tie 786. In this manner a force pulling in the direction of arrow 788 on distal end 790 of fabric core material 782 will cause ring 792 to be pulled to the right thus igniting smoke generator 780 as discussed above in relation to the smoke generators shown in FIGS. 33-38. Smoke generator 780 may or may not have an igniter spring as discussed above in § [0106].

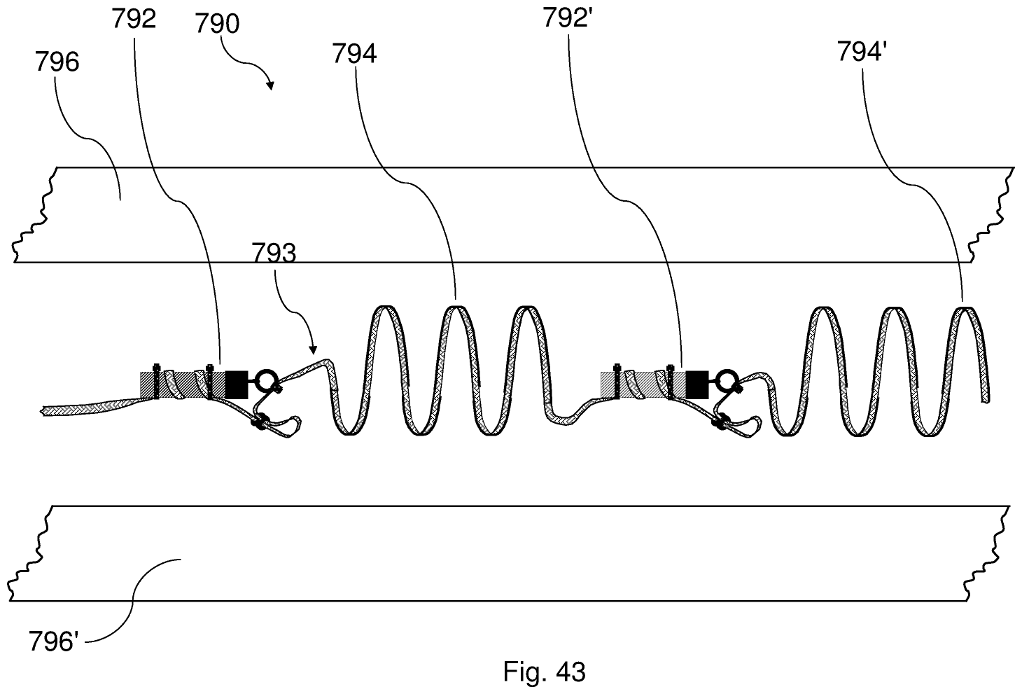

FIG. 43 shows a signal tape 790 according to this invention comprising smoke generators 792, 792′ joined by a continuous strip of fabric core material 793 which is attached to smoke generators 792, 792′ as shown in FIG. 40. Fabric core material 793 is arrayed in a sinusoidal pattern between smoke generators 792, 792′ as shown at 794 and 794′. Thin thermoplastic tapes 796, 796′ are laminated together with all of the signal tape 790 components to form a continuous signal tape and provide environmental protection for the signal tape 790 components. Tapes 796, 796′ are joined or sealed so as to fully encase and protect smoke generators 792, 792′, and all the components of the smoke generators. The tapes 796, 796′ may be in the form of tape or any other form of casing which is long and thin but sufficiently robust to provide an environmental barrier as well as withstand the forces of installation. Smoke generators 792, 792′ may be aligned along the tape to allow for the tape to be rolled up for compact storage [as shown in FIG. 6] and installation in the same manner as marker tape is currently installed above a buried infrastructure. Tapes 796, 796′ must be fully sealed and must provide an impermeable environmental barrier to water and other underground fluids and must provide a protective layer able to withstand the forces of installation and backfill during installation so that smoke generators 792, 792′ and all of their components remain fully protected and operable in situ. Smoke generators 792, 792′ may or may not have an igniter spring as discussed above in § [0106].

The extra core material in sinusoidal patterns as shown at 794, 794′ of signal tape 790 permits the signal tape to be easily caught and brought to the surface by an excavator bucket digging along the longitudinal direction of the signal tape. A strike by an excavator bucket at an angle approximately 90° to the longitudinal axis poses few issues for catching the signal tape and bringing it to the surface, but the strike in a direction along the longitudinal axis is a more difficult situation—thus the extra material in the sinusoidal pattern. It is noted that the pattern in which the extra core material is arrayed may be other than sinusoidal. For example, the extra core material is arrayed might be a square wave, a triangular wave or a rectangular wave.

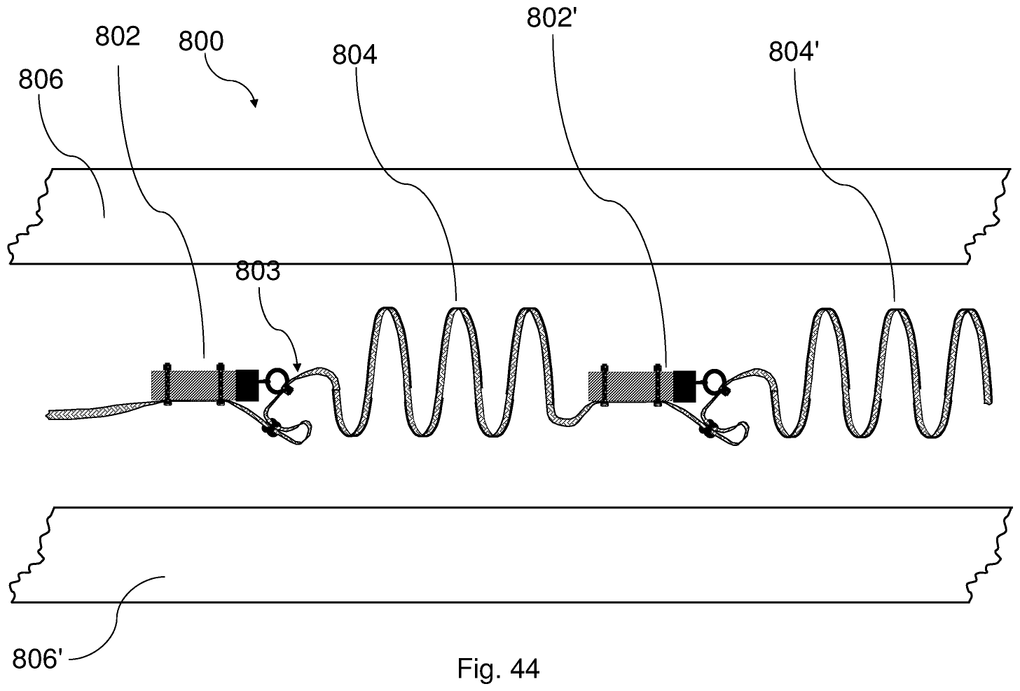

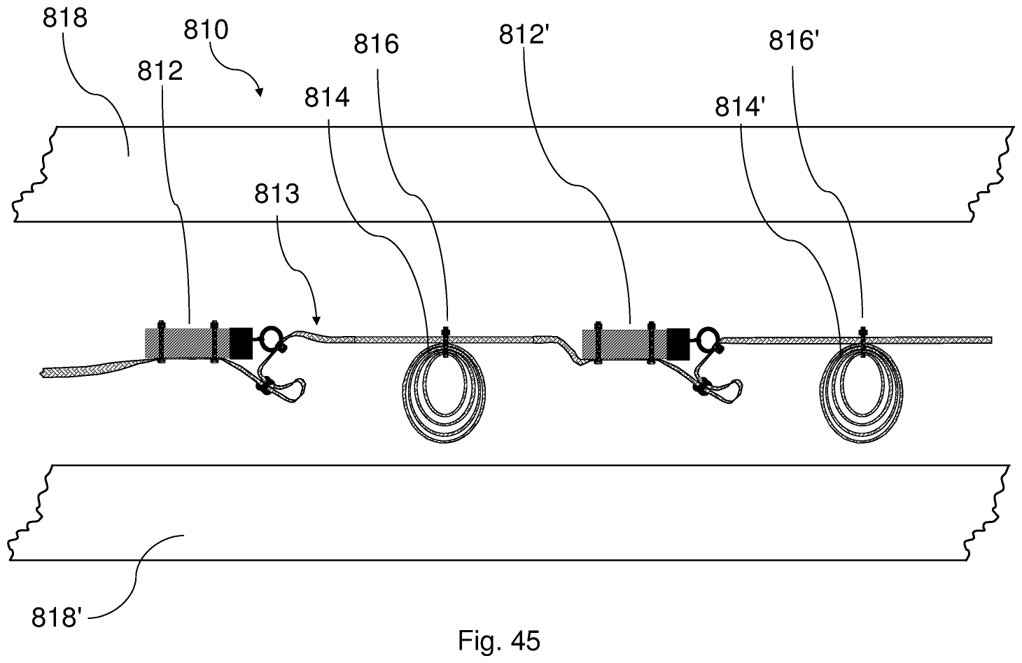

FIG. 44 shows a signal tape 800 according to this invention comprising smoke generators 802, 802′ joined by a continuous strip of fabric core material 803 which is attached to smoke generators 802, 802′ identical to smoke generator 756′ as shown in FIG. 41. Fabric core material 803 is arrayed in a sinusoidal pattern between smoke generators 802, 802′ as shown at 804 and 804′. Tapes 806, 806′ are joined or sealed so as to fully encase and protect smoke generators 802, 802′, and all the components of the smoke generators. The tapes 806, 806′ may be in the form of tape or any other form of casing which is long and thin but sufficiently robust to provide an environmental barrier as well as withstand the forces of installation. Smoke generators 802, 802′ may be aligned along the tape to allow for the tape to be rolled up for compact storage [as shown in FIG. 6] and installation in the same manner as marker tape is currently installed above a buried infrastructure. Tapes 806, 806′ must be fully sealed and must provide an impermeable environmental barrier to water and other underground fluids and must provide a protective layer able to withstand the forces of installation and backfill during installation so that smoke generators 802, 802′ and all of their components remain fully protected and operable in situ. Smoke generators 802, 802′ may or may not have an igniter spring as discussed above in § [0106].

FIG. 45 shows a signal tape 810 according to this invention comprising smoke generators 812, 812′ joined by a continuous strip of fabric core material 813 which is attached to smoke generators 812, 812′ identical to smoke generator 756′ as shown in FIG. 41. Fabric core material 813 is arrayed in a straight line pattern between smoke generators 812, 812′ as shown in FIG. 45. Extra fabric core material 813 is gathered in loops 814 and 814′ and attached to itself with cable ties 816, 816′ as shown. Tapes 818, 818′ are joined or sealed so as to fully encase and protect smoke generators 812, 812′, and all the components of the smoke generators. The tapes 818, 818′ may be in the form of tape or any other form of casing which is long and thin but sufficiently robust to provide an environmental barrier as well as withstand the forces of installation. Smoke generators 812, 812′ may be aligned along the tape to allow for the tape to be rolled up for compact storage [as shown in FIG. 6]. Smoke generators 812, 812′ may or may not have an igniter spring as discussed above in § [0106].

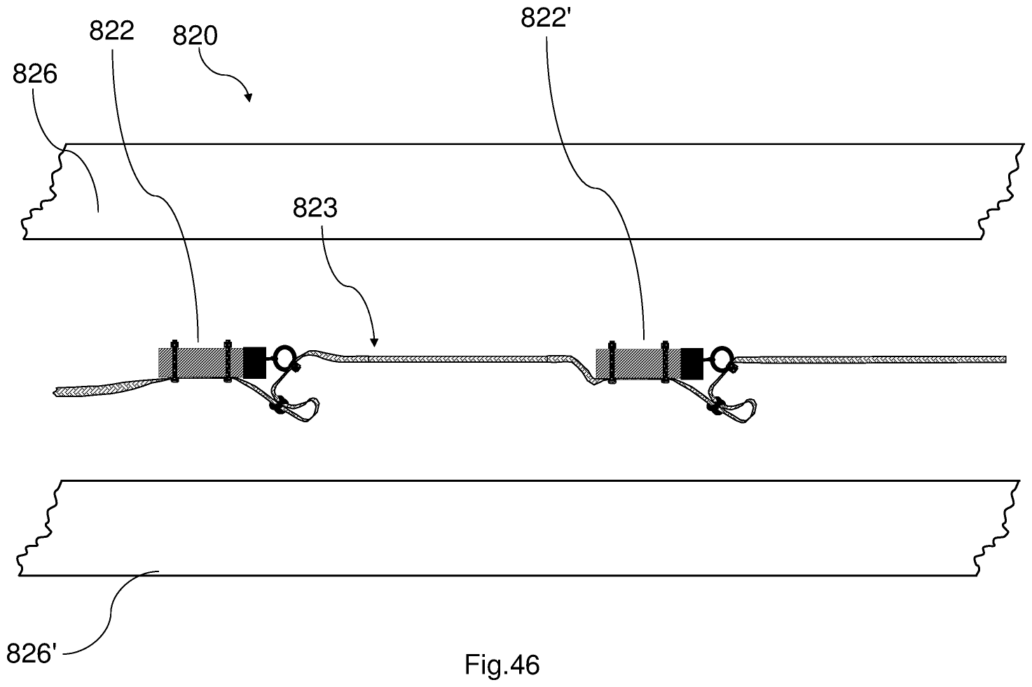

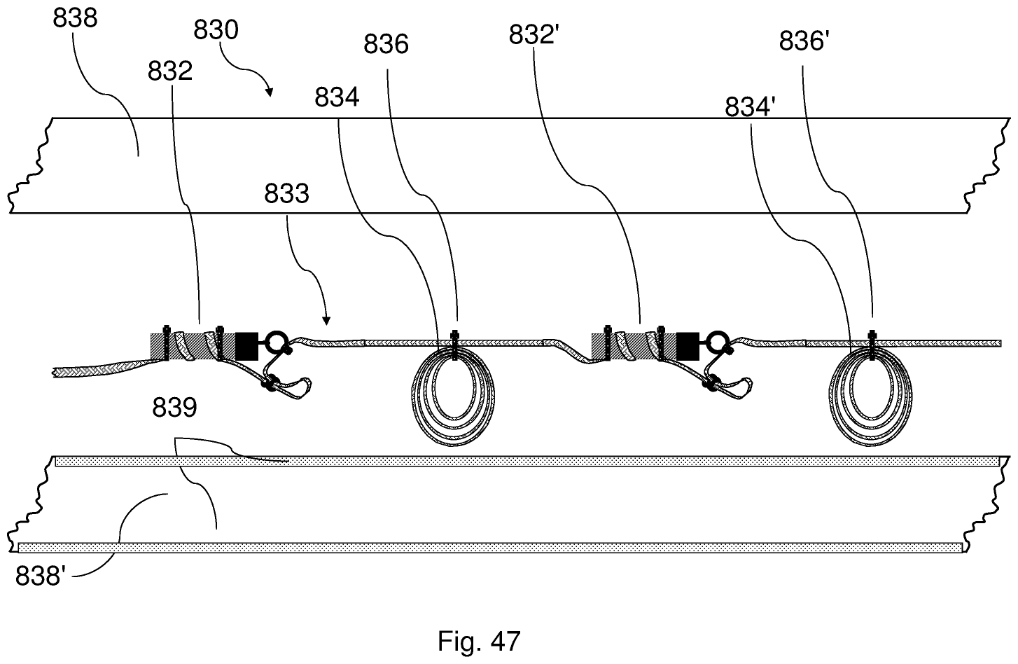

FIG. 46 shows a signal tape 820 according to this invention comprising smoke generators 822, 822′ joined by a continuous strip of fabric core material 823 which is attached to smoke generators 822, 822′ identical to smoke generator 756′ as shown in FIG. 41. Fabric core material 823 is arrayed in a straight line pattern between smoke generators 822, 822′ as shown in FIG. 46. Tapes 826, 826′ are joined or sealed so as to fully encase and protect smoke generators 822, 822′, and all the components of the smoke generators. The tapes 826, 826′ may be in the form of tape or any other form of casing which is long and thin but sufficiently robust to provide an environmental barrier as well as withstand the forces of installation. Smoke generators 822, 822′ may be aligned along the tape to allow for the tape to be rolled up for compact storage [as shown in FIG. 6]. Smoke generators 822, 822′ may or may not have an igniter spring as discussed above in § [0106].

FIG. 47 shows a signal tape 830 according to this invention comprising smoke generators 832, 832′ joined by a continuous strip of fabric core material 833 which is attached to smoke generators 832, 832′ identical to smoke generator 756 as shown in FIG. 40. Fabric core material 833 is arrayed in a straight line pattern between smoke generators 832, 832′ as shown in FIG. 46. Extra fabric core material 833 is gathered in loops 834 and 834′ and attached to itself with cable ties 836, 836′ as shown. Tapes 838, 838′ are joined or sealed so as to fully encase and protect smoke generators 832, 832′, and all the components of the smoke generators. The tapes 838, 838′ may be in the form of tape or any other form of casing which is long and thin but sufficiently robust to provide an environmental barrier as well as withstand the forces of installation. Tapes 838, 838′ may comprise adhesive strips 839 to adhere tapes 838, 838′ together. In addition, the entire inner face of tape 838 and/or 838′ may be coated with adhesive. Smoke generators 832, 832′ may be aligned along the tape to allow for the tape to be rolled up for compact storage [as shown in FIG. 6]. Smoke generators 832, 832′ may or may not have an igniter spring as discussed above in § [0106].

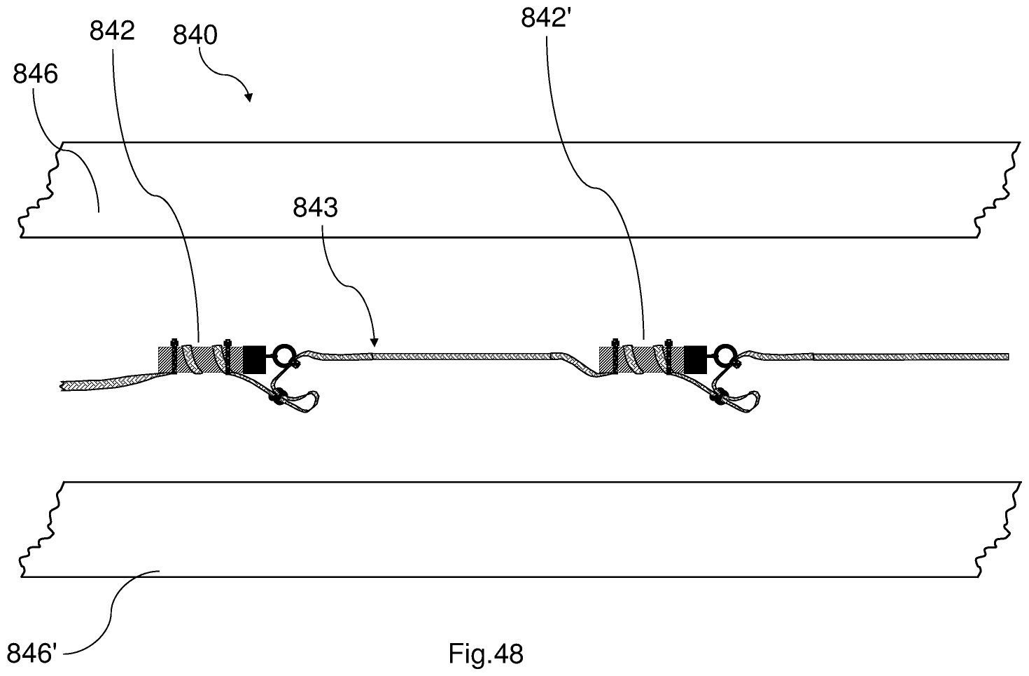

FIG. 48 shows a signal tape 840 according to this invention comprising smoke generators 842, 842′ joined by a continuous strip of fabric core material 843 which is attached to smoke generators 842, 842′ identical to smoke generator 756 as shown in FIG. 40. Fabric core material 843 is arrayed in a straight line pattern between smoke generators 842, 842′ as shown in FIG. 47. Tapes 846, 846′ are joined or sealed so as to fully encase and protect smoke generators 842, 842′, and all the components of the smoke generators. The tapes 846, 846′ may be in the form of tape or any other form of casing which is long and thin but sufficiently robust to provide an environmental barrier as well as withstand the forces of installation. Smoke generators 842, 842′ may be aligned along the tape to allow for the tape to be rolled up for compact storage [as shown in FIG. 6]. Smoke generators 842, 842′ may or may not have an igniter spring as discussed above in § [0106].

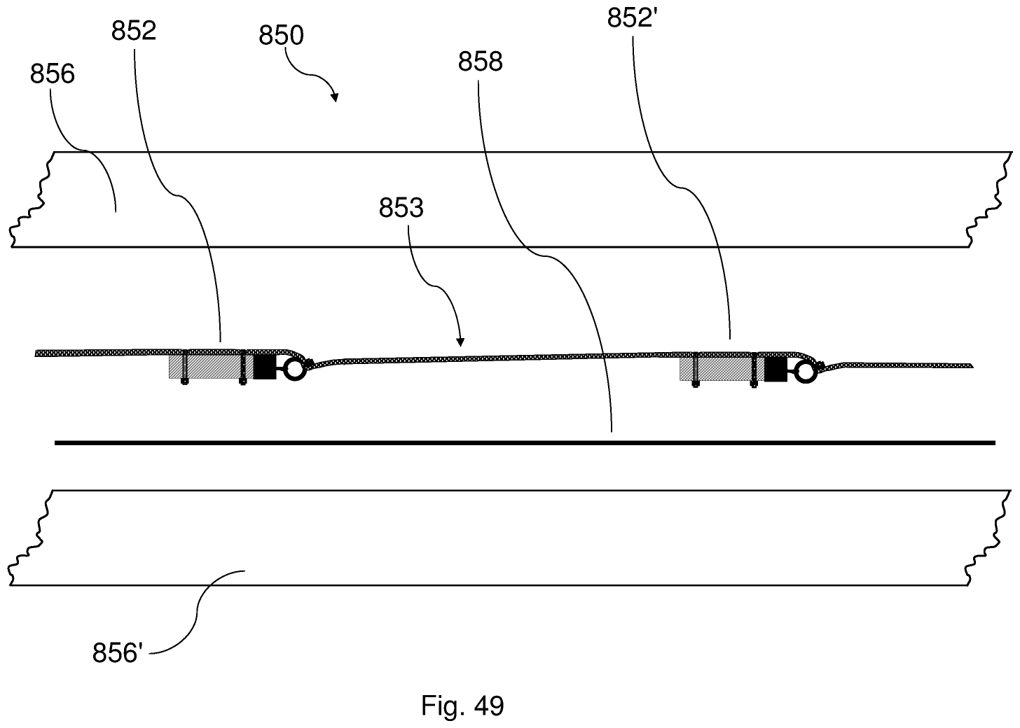

FIG. 49 shows a signal tape 850 according to this invention comprising smoke generators 852, 852′ joined by a continuous strip of shock cord core material 853 which is attached to smoke generators 852, 852′ identical to smoke generator 780 as shown in FIG. 42. Shock cord core material 853 is arrayed in a straight line pattern between smoke generators 852, 852′ as shown in FIG. 48. Tapes 856, 856′ are joined or sealed so as to fully encase and protect smoke generators 852, 852′ , and all the components of the smoke generators. The tapes 856, 856′ may be in the form of tape or any other form of casing which is long and thin but sufficiently robust to provide an environmental barrier as well as withstand the forces of installation. Smoke generators 852, 852′ may be aligned along the tape to allow for the tape to be rolled up for compact storage [as shown in FIG. 6]. Smoke generators 852, 852′ may or may not have an igniter spring as discussed above in § [0106]. As shown in FIG. 49, signal tape 850 may include a conventional tracer wire 858 to aid in locating signal tape 850 when it is buried underground. The presence of conventional tracer wire 858 permits conventional locating equipment to locate from the surface the underground position of signal tape 850.

It should be understood that any smoke generator shown in this disclosure, unless specifically identified otherwise may or may not contain an ignition spring. Any or all of the signal tapes disclosed herein may also have conventional tracer wire incorporated therein as shown for signal tape 850 in FIG. 49. If incorporated, the tracer wire and the associated signal tape should be buried in a known [and constant] spatial relationship to the underground utility. For example, the tracer wire [or signal tape] may be buried a few inches above [or below] the underground utility or a few inches to one side or the other of the underground utility. The important thing is that, whatever the orientation of the tracer wire [signal tape] to the underground utility, that orientation must be constant and known. When it is desired to locate the underground utility, the tracer wire an AC current is induced in the tracer wire inside the signal tape in order to create a magnetic field. This magnetic field is broadcast from the tracer wire and this magnetic field can be remotely detected and mapped from the ground surface using hand-held conventional magnetic locating devices [receivers]. For example, the “Maggie” or the “GA-92XTd” magnetic locating receivers from Schonstedt Instrument Company. When the tracer wire's location has been mapped, because the spatial relationship between the location of the tracer wire and the underground utility is known, mapping the tracer wire enables the mapping of the underground utility.

A number of companies sell this type of magnetic locating equipment. For example, the CL 300 Cable Locating Kit from Schonstedt Instrument Company contains a magnetic receiver [such as the “Maggie” or the “GA-92XTd” or a similar receiver] a transmitter to apply an AC current directly to a metallic underground utility, to induce an AC current using an inductive clamp, or by remote induction, and the various accessories necessary to map underground utilities or tracer wire. Using the Schonstedt system, the transmitter has the capability to directly broadcast a varying magnetic field from the surface of the ground, which varying magnetic field will then induce the desired magnetic fields in the buried metallic underground utility or tracer wire. Obviously, this last option is more limited with regard to range and the direct electrical connection is the preferred operating mode.

The smoke generators shown herein all use a smoke producing compound that gives smoke with a cool pyrotechnic reaction. The temperatures reached in this reaction are not sufficiently high so as to be capable of igniting natural gas or other hydrocarbons leaked in the vicinity of an active smoke generator. It should be understood, that—even though all of the smoke generators specifically shown in this application use a cool pyrotechnic reaction to generate smoke—other types of reactions could be used to generate the desired smoke. For example, chemical reactions between different liquid compounds could be utilized. Compressed, colored gas could also be utilized. These and other types of reactions to produce smoke are discussed in commonly owned U.S. Pat. No. 9,568,121 issued on 14 Feb. 2017. It should be understood that warning indicia [not shown in the drawings] may be imprinted upon the thermoplastic environmental protection tapes which indicia may comprise the type of buried utility, brightly colored backgrounds and industry standard color codes for various buried infrastructure.

The invention herein disclosed relates to signal tape which provides a localized, immediate and forceful signal to an excavation operator of the immediate proximity of and of impending damage to buried infrastructure. Many specific details of certain embodiments of the invention have been set forth above and in FIGS. 1-49 of the drawings to provide a thorough understanding of such embodiments. One skilled in the art, however, will understand that the present invention may have additional embodiments, or that the present invention may be practiced without several of the details described in the foregoing specification.

1. An elongated signal tape comprising:
a core material and protective material enclosing said core material;
said protective material comprising a top sheet of thermoplastic material having a first predetermined length and a first predetermined width and a bottom sheet of thermoplastic material having a second predetermined length and a second predetermined width with said first and said second predetermined lengths being approximately equal and with said first and second predetermined widths being approximately equal;
said core material further comprising a generally non-stretchable material positioned between said top and bottom thermoplastic sheets, said material having:
a predetermined third length,
an outer surface,
a maximum lateral dimension of approximately one inch [or approximately 2.54 cm],
a minimum predetermined tensile strength;
said core material having at least one smoke generator fastened thereto along said predetermined third length;
said at least one smoke generator comprising a smoke producing composition and an igniter portion embedded in said smoke producing composition with an ignition wire having first and second ends with said first end embedded within said igniter portion
and with said second end attached to said core material such that relative motion between said core material and said smoke generator will cause said igniter wire to be pulled out of said igniter portion, thus igniting said at least one smoke generator; and,
said elongated marker tape further comprising adhesive, bonding at least one of the top or bottom sheet of thermoplastic material to a substantial portion of the outer surface of said core material and also bonding the outer edges of said top and bottom thermoplastic sheets together.

2. The elongated signal tape of claim 1 wherein said general non-stretchable core material comprises a strip further comprising an upper surface and a lower surface with a maximum width of approximately one inch [or approximately 2.54 cm] and a maximum thickness of approximately ¼ inch [or approximately 0.16 cm].

3. The elongated signal tape of claim 1 wherein said generally non-stretchable core material comprises a rope-like material with the maximum diameter of said rope-like material being approximately one inch [or approximately 2.54 cm].

4. The elongated signal tape of claim 1 wherein said minimum tensile strength of said core material is approximately 400 lb_{f} [or approximately 1780 N] and said predetermined third length of said core material is approximately twice the predetermined first length of said top thermoplastic sheet.

5. The elongated signal tape of claim 2 wherein said predetermined third length of said core material is approximately equal to said predetermined first length of said top thermoplastic sheet and said minimum predetermined tensile strength is approximately 6000 lb_{f} [or approximately 26,700 N].

6. The elongated signal tape of claim 3 wherein said predetermined third length of said core material is approximately equal to said predetermined first length of said top thermoplastic sheet and said minimum predetermined tensile strength is approximately 6000 lb_{f} [or approximately 26,700 N].

7. The elongated signal tape of claim 4 wherein said core material is positioned between said top and bottom thermoplastic sheets in a predetermined waveform pattern.

8. The elongated signal tape of claim 7 wherein said predetermined waveform pattern is sinusoidal.

9. The elongated signal tape of claim 7 wherein said predetermined waveform pattern is a triangular wave.

10. The elongated signal tape of claim 7 wherein said predetermined waveform pattern is a square wave.

11. The elongated signal tape of claim 7 wherein said predetermined waveform pattern is a rectangular wave.

12. The elongated signal tape of claim 1 wherein a generally straight tracer wire having a predetermined length approximately equal to said predetermined first length of said top thermoplastic sheet is positioned between said top and bottom thermoplastic sheets.

13. The elongated signal tape of claim 1 wherein said minimum tensile strength of said core material is approximately 3,000 lb_{f} [or approximately 13,350 N], said core material is a strip with a maximum width of approximately 1 inch [or approximately 2.54 cm] and said core material has a predetermined thickness of approximately one-sixteenth of an inch [or approximately 0.016 cm] and said predetermined length of said core material is approximately 1.5 times the predetermined length of said top thermoplastic sheet.

14. The elongated signal tape of claim 13 wherein said core material is positioned between said top and bottom thermoplastic sheets in a predetermined waveform pattern.

15. The elongated signal tape of claim 13 wherein said predetermined waveform pattern is sinusoidal.

16. The elongated signal tape of claim 13 wherein said predetermined waveform pattern is a triangular wave.

17. The elongated signal tape of claim 13 wherein said predetermined waveform pattern is a square wave.

18. The elongated signal tape of claim 13 wherein said predetermined waveform pattern is a rectangular wave.

19. An elongated signal tape comprising:
protective material comprising a top sheet of thermoplastic material having a first predetermined length and a first predetermined width and a bottom sheet of thermoplastic material having a second predetermined length and a second predetermined width with said first and said second predetermined lengths being approximately equal and with said first and second predetermined widths being approximately equal;
a stretchable core material having a non-stretched predetermined length and being positioned between said top and bottom thermoplastic sheets, with said stretchable core material being capable of being stretched, without breaking, to approximately 1.5 times its non-stretched predetermined length, said core material having:
an outer surface,
a maximum lateral dimension of approximately one inch [or approximately 2.54 cm],
a minimum predetermined tensile strength, said core material further comprising a generally non-stretchable material positioned between said top and bottom thermoplastic sheets, said material having:
a predetermined third length,
an outer surface,
a maximum lateral dimension of approximately one inch [or approximately 2.54 cm],
a minimum predetermined tensile strength;
said core material having at least one smoke generator fastened thereto along said predetermined third length;
said at least one smoke generator comprising a smoke producing composition and an igniter portion embedded in said smoke producing composition with an ignition wire having first and second ends with said first end embedded within said igniter portion
and with said second end attached to said core material such that relative motion between said core material and said smoke generator will cause said igniter wire to be pulled out of said igniter portion, thus igniting said at least one smoke generator; and,
said elongated marker tape further comprising adhesive, bonding at least one of the top or bottom sheet of thermoplastic material to a substantial portion of the outer surface of said core material and also bonding the outer edges of said top and bottom thermoplastic sheets together.

20. The elongated signal tape of claim 19 wherein said minimum predetermined tensile strength is at least 400 lb_{f} [or approximately 1780 N].

21. The elongated signal tape of claim 19 wherein a generally straight tracer wire having a predetermined length approximately equal to said predetermined length of said top thermoplastic sheet is positioned between said top and bottom thermoplastic sheets.

22. The elongated marker tape of claim 19 wherein the stretchable core material non-stretched predetermined length is approximately twice the predetermined length of said top thermoplastic sheet and said stretchable core material minimum tensile strength is approximately 100 lb_{f} [or approximately 445 N].

23. The elongated signal tape of claim 22 wherein said core material is positioned between said top and bottom thermoplastic sheets in a predetermined waveform pattern wherein said elongated signal tape makes multiple, loud warning sounds as it is being pulled from the ground by a backhoe.

24. The elongated signal tape of claim 23 wherein said predetermined waveform pattern is sinusoidal.

25. The elongated signal tape of claim 23 wherein said predetermined waveform pattern is a triangular wave.

26. The elongated signal tape of claim 23 wherein said predetermined waveform pattern is a square wave.

27. The elongated signal tape of claim 23 wherein said predetermined waveform pattern is a rectangular wave.

28. The elongated signal tape of claim 1 wherein said igniter portion further comprises an elongated fuse with one end of said fuse embedded in said smoke producing composition and with the other end of said fuse embedded in a friction igniter,
with said friction igniter further comprising an elongated ignition wire adapted to be pulled out of said friction igniter with one end of said ignition wire being embedded in said friction igniter and with the other end of said ignition wire being attached to said core material such that relative movement between said smoke generator and said core material will cause the ignition wire to be pulled out of said friction igniter thus igniting said fuse and thus igniting said smoke producing material.

29. The elongated signal tape of claim 28 wherein said other end of said igniter wire is attached to one end of an ignition spring with said ignition spring having a predetermined spring constant and with the other end of said ignition spring being attached to said core material such that relative movement between said smoke generator and said core material will cause the ignition spring to first stretch and store energy and then to release said energy and pull said ignition wire out of said friction igniter thus igniting said fuse and thus igniting said smoke producing material.
